(19) United States
(12) Patent Application Publication
(10) Pub. No.: US 2017/0374644 A1
(43) Pub. Date: Dec. 28, 2017

(54) METHOD FOR TRANSMITTING PAGING IN WIRELESS COMMUNICATION SYSTEM, AND APPARATUS THEREFOR

(71) Applicant: LG ELECTRONICS INC., Seoul (KR)

(72) Inventors: Jinsook RYU, Seoul (KR); Hyunsook KIM, Seoul (KR); Laeyoung KIM, Seoul (KR); Jaehyun KIM, Seoul (KR); Taehun KIM, Seoul (KR)

(73) Assignee: LG ELECTRONICS INC., Seoul (KR)

(21) Appl. No.: 15/536,635

(22) PCT Filed: Dec. 15, 2015
(86) PCT No.: PCT/KR2015/013766

§ 371 Date: Jun. 16, 2017

Related U.S. Application Data
(60) Provisional application No. 62/092,183, filed on Dec. 15, 2014.

(51) Int. Cl. H04W 68/02; H04W 76/02; H04W 76/04; H04W 68/12

(52) U.S. Cl. CPC H04W 68/02; H04W 76/046; H04W 76/021; H04W 68/12

(57) ABSTRACT

Disclosed are a method for transmitting paging in a wireless communication system, and an apparatus therefor. Particularly, a method for transmitting, by a base station (eNB), paging in a wireless communication system comprises the steps of: receiving, from a mobility management entity (MME), a paging message including settings for retransmission of paging information by the base station; and transmitting the paging information to a terminal via a paging control channel (PCCH), wherein the paging information may be transmitted to the terminal by the base station a predetermined number of times.

### TECHNICAL FIELD

The present invention relates to a wireless communication system. More specifically, the present invention relates to a method for performing or supporting (re)transmission of a paging message and an apparatus supporting the method.

### BACKGROUND ART

A mobile communication system has been developed to provide a voice service while guaranteeing activity of a user. However, the mobile communication system extends an area up to a data service as well as a voice and at present, a short phenomenon of a resource is caused due to an explosive increase of traffic and uses require a higher-speed service, and as a result, a more developed mobile communication system is required.

Requirements of a next-generation mobile communication system largely need to support accommodation of explosive data traffic, an epochal increase of transmission rate per user, accommodation of the significantly increased number of connection devices, very low end-to-end latency, and high energy efficiency. To this end, various technologies have been researched, which include dual connectivity, massive multiple input multiple output (MIMO), in-band full duplex, non-orthogonal multiple access (NOMA), super wideband supporting, device networking, and the like.

### SUMMARY OF INVENTION

### Technical Problem

An object of the present invention is to provide a method for performing a paging procedure for a specific cell (or a base station).

Also, an object of the present invention is to provide a method for a base station to perform retransmission (or repetition) of a paging message.

Technical objects of the present invention are not limited to those objects described above; other technical objects not mentioned above can be clearly understood from what are described below by those skilled in the art to which the present invention belongs.

### Technical Solution

According to one aspect of the present invention, a method for an eNB to transmit a paging message in a wireless communication system comprises receiving a paging message including configuration for retransmission of paging information by the eNB from a Mobility Management Entity (MME); and transmitting paging information to a UE through a PCCH (Paging Control Channel), wherein the eNB may transmit the paging information to the UE a predetermined number of times.

According to another aspect of the present invention, an eNB for transmitting a paging message in a wireless communication system comprises a communication module for transmitting and receiving a wired/wireless signal and a processor for controlling the communication module, wherein the processor is configured to receive a paging message including configuration of retransmission of paging information by the eNB from a MME and to transmit paging information to a UE through a PCCH (Paging Control Channel), wherein the eNB may transmit the paging information to the UE a predetermined number of times.

Preferably, the predetermined number may be determined by the eNB or may be determined in advance.

Preferably, the predetermined number may be determined by the eNB based on a paging resource of the eNB and/or the number of UEs to which the paging information is to be transmitted.

Preferably, if the number of transmissions of the paging information reaches the predetermined number, transmission of the paging information may be stopped.

Preferably, when an RRC connection request message is received from the UE in response to the paging information, transmission of the paging information may be stopped.

Preferably, the RRC connection request message may include S-TMSI (SAE Temporary Mobile Subscriber Identity) belonging to the paging information.

Preferably, the configuration for retransmission of paging information by the eNB may include the number of retransmissions of the paging information.

Preferably, the predetermined number may be configured by the number of retransmissions of the paging information.

Preferably, when the paging message is re-received from the MME, the paging information may be transmitted to the UE irrespective of the predetermined number.

### Advantageous Effects

According to an embodiment of the present invention, by performing retransmission (or repetition) of a paging message by an eNB, a paging message smoothly to a UE characterized by low mobility may be transmitted.

Also, according to an embodiment of the present invention, as an eNB performs retransmission (or repetition) of a paging message, a paging signaling overhead between an MME and the eNB may be reduced.

Also, according to an embodiment of the present invention, by performing retransmission (or repetition) of a paging message by an eNB, overhead of a paging resource may be reduced.

The advantageous effect that can be obtained from the present invention are not limited to those described above, and other effects not mentioned above can be understood clearly by those skilled in the art to which the present invention belongs from the following descriptions.

### DESCRIPTION OF DRAWINGS

The accompanying drawings, which are included to provide a further understanding of the invention as a part of detailed descriptions, illustrate embodiment(s) of the invention and together with the descriptions, serve to explain the technical principles of the invention.

FIG. 1 illustrates an Evolved Packet System (EPS) to which the present invention can be applied.

FIG. 2 illustrates one example of an Evolved Universal Terrestrial Radio Access Network (E-UTRAN) to which the present invention can be applied.

FIG. 3 illustrates structures of an E-UTRAN and an EPC in a wireless communication system to which the present invention may be applied.

FIG. 4 illustrates a radio interface protocol structure between a UE and an E-UTRAN in a wireless communication system to which the present invention may be applied.

FIG. 5 illustrates an S1 interface protocol structure in a wireless communication system to which the present invention may be applied.

FIG. 6 illustrates a physical channel structure in a wireless communication system to which the present invention may be applied.

FIG. 7 illustrates an EMM and ECM states in a wireless communication system to which the present invention may be applied.

FIG. 8 illustrates a bearer structure in a wireless communication system to which the present invention may be applied.

FIG. 9 illustrates transmission paths of a control plane and a user plane in an EMM registration state in a wireless communication system to which the present invention may be applied.

FIG. 10 illustrates an ECM connection establishment procedure in a wireless communication system to which the present invention may be applied.

FIG. 11 illustrates a contention-based random access procedure in a wireless communication system to which the present invention may be applied.

FIG. 12 illustrates a UE trigger service request procedure in a wireless communication system to which the present invention may be applied.

FIG. 13 illustrates a network trigger service request procedure in a wireless communication system to which the present invention may be applied.

FIG. 14 illustrates a paging procedure in a wireless communication system to which the present invention may be applied.

FIG. 15 illustrates one example of a paging method in a wireless communication system to which the present invention may be applied.

FIGS. 16 to 20 illustrate a paging transmission method according to one embodiment of the present invention.

FIG. 21 illustrates a block diagram of a communication device according to one embodiment of the present invention.

FIG. 22 illustrates a block diagram of a communication device according to one embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention can be embodied without the specific information.

For some cases, to avoid obscuring the technical principles of the present invention, structures and devices well-known to the public can be omitted or can be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by a upper node of the base station depending on situations. In other words, it is apparent that in a network consisting of a plurality of network nodes including a base station, various operations performed for communication with a UE can be performed by the base station or by network nodes other than the base station. The term Base Station (BS) can be replaced with a fixed station, Node B, evolved-NodeB (eNB), Base Transceiver System (BTS), or Access Point (AP). Also, a terminal can be fixed or mobile; and the term can be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter can be part of the base station, and a receiver can be part of the terminal. Similarly, in uplink transmission, a transmitter can be part of the terminal, and a receiver can be part of the base station.

Specific terms used in the following descriptions are introduced to help understanding the present invention, and the specific terms can be used in different ways as long as it does not leave the technical scope of the present invention.

The technology described below can be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA can be implemented by such radio technology as Universal Terrestrial Radio Access (UTRA) or CDMA2000. TDMA can be implemented by such radio technology as Global System for Mobile communications (GSM), General Packet Radio Service (GPRS), or Enhanced Data rates for GSM Evolution (EDGE). OFDMA can be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention can be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention can be supported by the documents above. Also, all of the terms disclosed in this document can be explained with reference to the standard documents.

To clarify the descriptions, this document is based on the 3GPP LTE/LTE-A, but the technical features of the present invention are not limited to the current descriptions.

Terms used in this document are defined as follows.
Universal Mobile Telecommunication System (UMTS): the 3rd generation mobile communication technology based on GSM, developed by the 3GPP
Evolved Packet System (EPS): a network system comprising an Evolved Packet Core (EPC), a packet switched core network based on the Internet Protocol (IP) and an access network such as the LTE and UTRAN. The EPS is a network evolved from the UMTS.
NodeB: the base station of the UMTS network. NodeB is installed outside and provides coverage of a macro cell.
eNodeB: the base station of the EPS network. eNodeB is installed outside and provides coverage of a macro cell.
User Equipment (UE): A UE can be called a terminal, Mobile Equipment (ME), or Mobile Station (MS). A UE can be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.
IP Multimedia Subsystem (IMS): a sub-system providing multimedia services based on the IP
International Mobile Subscriber Identity (IMSI): a globally unique subscriber identifier assigned in a mobile communication network
Machine Type Communication (MTC): communication performed by machines without human intervention. It may be called Machine-to-Machine (M2M) communication.
MTC terminal (MTC UE or MTC device): a terminal (for example, a vending machine, meter, and so on) equipped with a communication function operating through a mobile communication network and performing an MTC function
MTC server: a server on a network managing MTC terminals. It can be installed inside or outside a mobile communication network. It can provide an interface through which an MTC user can access the server. Also, an MTC server can provide MTC-related services to other servers (in the form of Services Capability Server (SCS)) or the MTC server itself can be an MTC Application Server.
(MTC) application: services (to which MTC is applied) (for example, remote metering, traffic movement tracking, weather observation sensors, and so on)
(MTC) Application Server: a server on a network in which (MTC) applications are performed
MTC feature: a function of a network to support MTC applications. For example, MTC monitoring is a feature intended to prepare for loss of a device in an MTC application such as remote metering, and low mobility is a feature intended for an MTC application with respect to an MTC terminal such as a vending machine.
MTC subscriber: an entity having a connection relationship with a network operator and providing services to one or more MTC terminals.
MTC group: an MTC group shares at least one or more MTC features and denotes a group of MTC terminals belonging to MTC subscribers.
Services Capability Server (SCS): an entity being connected to the 3GPP network and used for communicating with an MTC InterWorking Function (MTC-IWF) on a Home PLMN (HPLMN) and an MTC terminal.
External identifier: a globally unique identifier used by an external entity (for example, an SCS or an Application Server) of the 3GPP network to indicate (or identify) an MTC terminal (or a subscriber to which the MTC terminal belongs). An external identifier comprises a domain identifier and a local identifier as described below.
Domain identifier: an identifier used for identifying a domain in the control region of a mobile communication network service provider. A service provider can use a separate domain identifier for each service to provide an access to a different service.
Local identifier: an identifier used for deriving or obtaining an International Mobile Subscriber Identity (IMSI). A local identifier should be unique within an application domain and is managed by a mobile communication network service provider.
Radio Access Network (RAN): a unit including a Node B, a Radio Network Controller (RNC) controlling the Node B, and an eNodeB in the 3GPP network. The RAN is defined at the terminal level and provides a connection to a core network.
Home Location Register (HLR)/Home Subscriber Server (HSS): a database provisioning subscriber information within the 3GPP network. An HSS can perform functions of configuration storage, identity management, user state storage, and so on.
RAN Application Part (RANAP): an interface between the RAN and a node in charge of controlling a core network (in other words, a Mobility Management Entity (MME)/Serving GPRS (General Packet Radio Service) Supporting Node (SGSN)/Mobile Switching Center (MSC)).
Public Land Mobile Network (PLMN): a network formed to provide mobile communication services to individuals. The PLMN can be formed separately for each operator.
Non-Access Stratum (NAS): a functional layer for exchanging signals and traffic messages between a terminal and a core network at the UMTS and EPS protocol stack. The NAS is used primarily for supporting mobility of a terminal and a session management procedure for establishing and maintaining an IP connection between the terminal and a PDN GW.

In what follows, the present invention will be described based on the terms defined above.

Overview of System to Which the Present Invention may be Applied

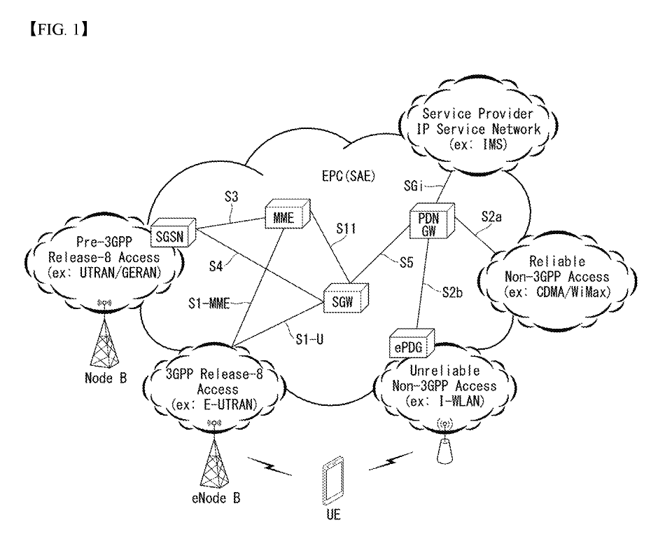

FIG. 1 illustrates an Evolved Packet System (EPS) to which the present invention can be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities can be established through an IP-based base station (for example, eNodeB), EPC, and application domain (for example, IMS). In other words, the EPC provides the architecture essential for implementing end-to-end IP services.

The EPC comprises various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, in case the UE moves across serving areas by the eNodeB, the SGW acts as an anchor point for local mobility. In other words, packets can be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW can support policy enforcement features, packet filtering, charging support, and so on. Also, the PDN GW can act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and Wimax).

In the example of a network structure as shown in FIG. 1, the SGW and the PDN GW are treated as separate gateways; however, the two gateways can be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability can access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points can be defined according to network structures.

TABLE 1

| Reference | |
|---|---|
| point | Description |
| S1-MME | Reference point for the control plane protocol between |
| | E-UTRAN and MME |
| S1-U | Reference point between E-UTRAN and Serving GW for |
| | the per bearer user plane tunneling and inter eNodeB |
| | path switching during handover |
| S3 | It enables user and bearer information exchange for inter |
| | 3GPP access network mobility in idle and/or active state. |
| | This reference point can be used intra-PLMN or inter-PLMN |
| | (e.g. in the case of Inter-PLMN HO). |
| S4 | It provides related control and mobility support between |
| | GPRS core and the 3GPP anchor function of Serving GW. In |
| | addition, if direct tunnel is not established, it provides |
| | the user plane tunneling. |
| S5 | It provides user plane tunneling and tunnel management |
| | between Serving GW and PDN GW. It is used for Serving |
| | GW relocation due to UE mobility if the Serving GW |
| | needs to connect to a non-collocated PDN GW for the |
| | required PDN connectivity. |
| S11 | Reference point for the control plane protocol between |
| | MME and SGW |
| SGi | It is the reference point between the PDN GW and the packet |
| | data network. Packet data network may be an operator |
| | external public or private packet data network or an intra- |
| | operator packet data network (e.g., for provision of IMS |
| | services). This reference point corresponds to Gi for 3GPP |
| | accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

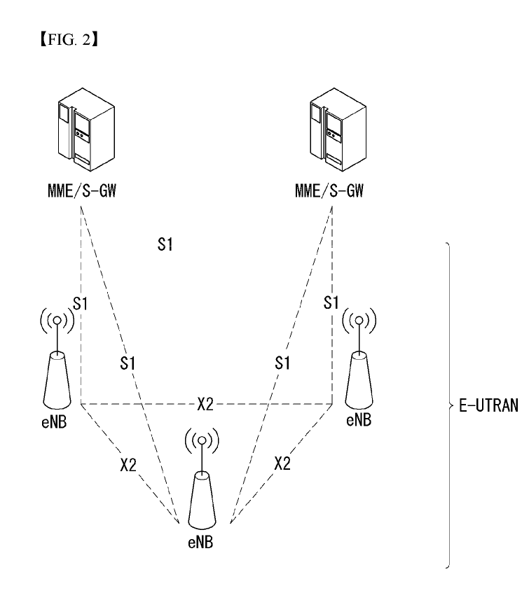

FIG. 2 illustrates one example of an Evolved Universal Terrestrial Radio Access Network (E-UTRAN) to which the present invention can be applied.

The E-UTRAN system has evolved from an existing UTRAN system and may be the 3GPP LTE/LTE-A system, for example. A communication system is disposed over a wide area to provide various communication services including voice communication through IMS and packet data (for example, VoIP (Voice over Internet Protocol)).

Referring to FIG. 2, an E-UMTS network comprises an E-UTRAN, EPC, and one or more UEs. The E-UTRAN comprises eNBs providing a UE with a control plane and user plane protocols, where the eNBs are connected to each other through X2 interface.

The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The S1 control plane interface (S1-MME) is defined between the eNB and the Mobility Management Entity (MME). The S1 interface performs the functions of EPS bearer service management, NAS signaling transport, network sharing, MME load balancing management, and so on. The S1 interface supports many-to-many-relation between the eNB and the MME/S-GW.

An MME is capable of performing various functions such as NAS signaling security, AS (Access Stratum) security control, inter-CN (Core Network) signaling for supporting mobility among 3GPP access networks, IDLE mode UE reachability (including performing and controlling retransmission of a paging message), TAI (Tracking Area Identity) management (for IDLE and active mode UEs), PDN GW and SGW selection, MME selection for handover in which MMEs are changed, SGSN selection for handover to a 2G or 3G 3GPP access network, roaming, authentication, bearer management function including dedicated bearer establishment, and support for transmission of a PWS (Public Warning System) (including Earthquake and Tsunami Warning System (ETWS) and Commercial Mobile Alert System (CMAS)) message.

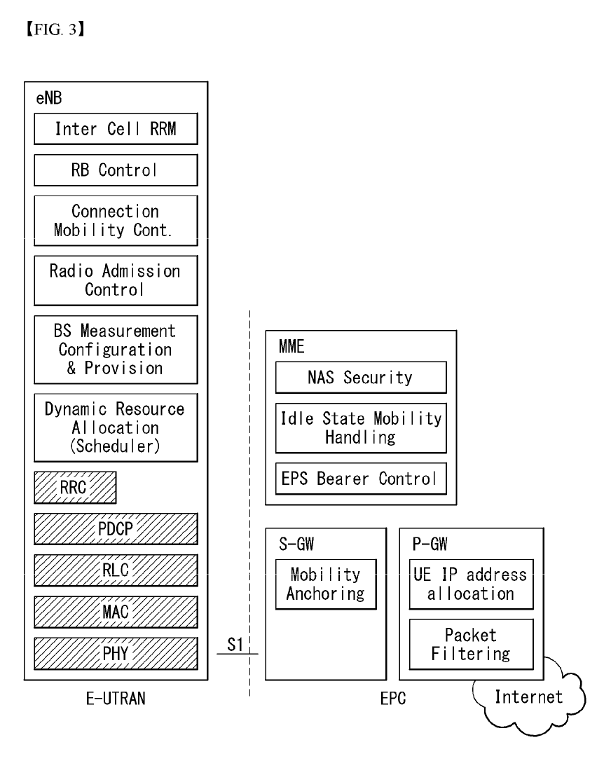

FIG. 3 illustrates structures of an E-UTRAN and an EPC in a wireless communication system to which the present invention may be applied.

Referring to FIG. 3, an eNB is capable of performing functions such as selection of a gateway (for example, MME), routing to a gateway during RRC (Radio Resource Control) activation, scheduling and transmission of a BCH (Broadcast Channel), dynamic resource allocation for a UE in uplink and downlink transmission, and mobility control connection in an LTE ACTIVE state. As described above, a gateway belonging to an EPC is capable of performing functions such as paging origination, LTE IDLE state management, ciphering of a user plane, SAE (System Architecture Evolution) bearer control, and ciphering of NAS signaling and integrity protection.

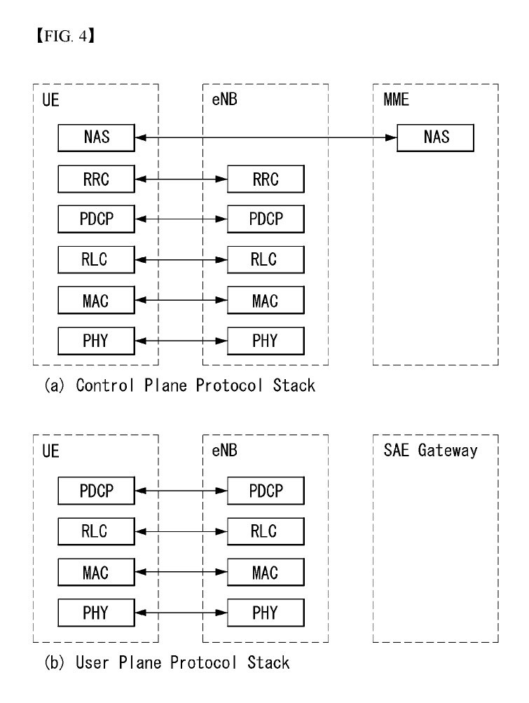

FIG. 4 illustrates a radio interface protocol structure between a UE and an E-UTRAN in a wireless communication system to which the present invention can be applied.

FIG. 4(a) illustrates a radio protocol structure for the control plane, and FIG. 4(b) illustrates a radio protocol structure for the user plane.

With reference to FIG. 4, layers of the radio interface protocol between the UE and the E-UTRAN can be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH can carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, in case the MAC layer performs the RLC function, the RLC layer can be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and includes unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers can be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells can be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service can be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

A logical channel lies above a transmission channel and is mapped to the transmission channel. The logical channel may be divided into a control channel for delivering control area information and a traffic channel for delivering user area information. The control channel may include a BCCH (Broadcast Control Channel), PCCH (Paging Control Channel), CCCH (Common Control Channel), DCCH (Dedicated Control Channel), and MCCH (Multicast Control Channel). The traffic channel may include a DTCH (Dedicated Traffic Channel) and MTCH (Multicast Traffic Channel). The PCCH is a downlink channel for delivering paging information and is used when a network does not know the cell to which a UE belongs. The CCCH is used by a UE that does not have an RRC connection to a network. The MCCH is a point-to-multipoint downlink channel used for delivering MBMS (Multimedia Broadcast and Multicast Service) control information from a network to a UE. The DCCH is a point-to-point bi-directional channel used by a UE with an RRC connection delivering dedicated control information between a UE and a network. The DTCH is a point-to-point channel dedicated to one UE for delivering user information that may exist in an uplink and downlink. The MTCH is a point-to-multipoint downlink channel for delivering traffic data from a network to a UE.

In the case of an uplink connection between a logical channel and a transport channel, the DCCH may be mapped to a UL-SCH, and the DTCH may be mapped to a UL-SCH, and the CCCH may be mapped to a UL-SCH. In the case of a downlink connection between a logical channel and a transport channel, the BCCH may be mapped to a BCH or DL-SCH, the PCCH may be mapped to a PCH, the DCCH may be mapped to a DL-SCH, the DTCH may be mapped to a DL-SCH, the MCCH may be mapped to an MCH, and the MTCH may be mapped to the MCH.

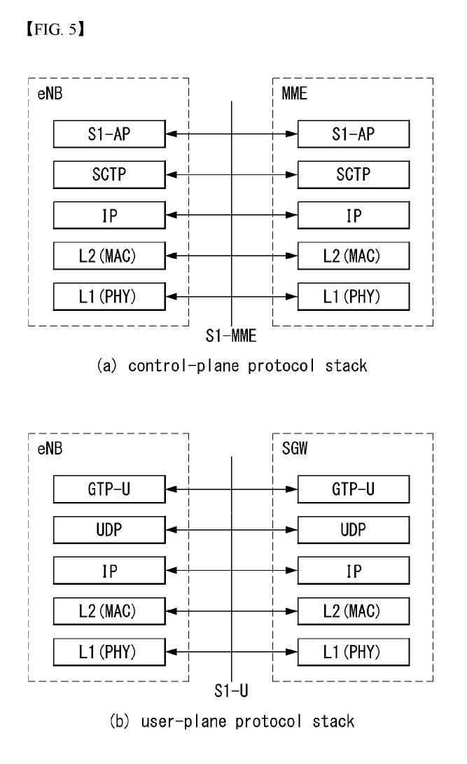

FIG. 5 illustrates an S1 interface protocol structure in a wireless communication system to which the present invention can be applied.

FIG. 5(a) illustrates the control plane protocol stack in the S1 interface, and FIG. 5(b) illustrates the user plane interface protocol structure in the S1 interface.

With reference to FIG. 5, the S1 control plane interface (S1-MME) is defined between the eNB and the MME. Similar to the user plane, the transport network layer is based on IP transmission. However, to ensure reliable transmission of message signaling, the transport network layer is added to the Stream Control Transmission Protocol (SCTP) layer which sits on top of the IP layer. The application layer signaling protocol is called S1 Application Protocol (S1-AP).

The SCTP layer provides guaranteed delivery of application layer messages.

The transport IP layer employs point-to-point transmission for Protocol Data Unit (PDU) signaling transmission.

For each S1-MME interface instance, single SCTP association uses a pair of stream identifiers for the S-MME common procedure. Only part of stream identifier pairs is used for the S1-MME dedicated procedure. The MME communication context identifier is allocated by the MME for the S1-MME dedicated procedure, and the eNB communication context identifier is allocated by the eNB for the S1-MME dedicated procedure. The MME communication context identifier and the eNB communication context identifier are used for identifying a UE-specific S1-MME signaling transmission bearer. The communication context identifier is delivered within each S1-AP message.

In case the S1 signaling transport layer notifies the S1AP layer of disconnection of signaling, the MME changes the state of the UE which has used the corresponding signaling connection to ECM-IDLE state. And the eNB releases RRC connection of the corresponding UE.

The S1 user plane interface (S1-U) is defined between eNB and S-GW. The S1-U interface provides non-guaranteed delivery of the user plane PDU between the eNB and the S-GW. The transport network layer is based on IP transmission, and the GPRS Tunneling Protocol User Plane (GTP-U) layer is used on top of the UDP/IP layer to deliver the user plane PDU between the eNB and the S-GW.

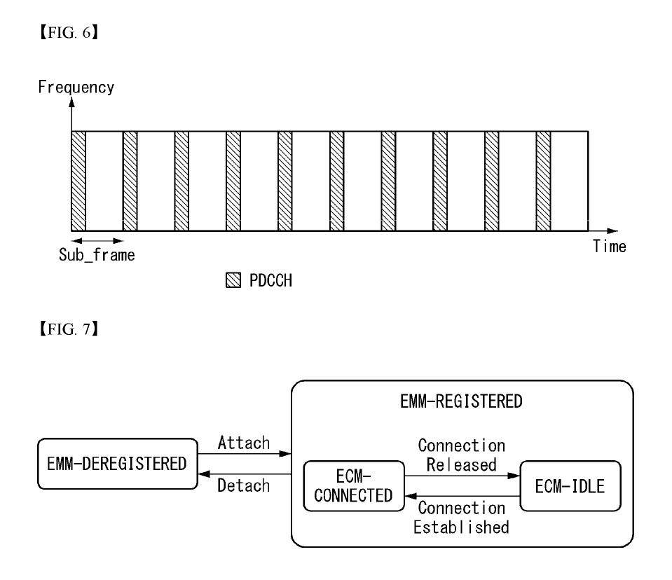

FIG. 6 illustrates a physical channel structure in a wireless communication system to which the present invention may be applied.

Referring to FIG. 6, a physical channel delivers signaling and data by using a radio resource comprising one or more subcarriers in the frequency domain and one or more symbols in the time domain.

One subframe having a length of 1.0 ms comprises a plurality of symbols. A specific symbol(s) of a subframe (for example, a first symbol of a subframe) may be used for a PDCCH. The PDCCH carries information about dynamically allocated resources (for example, resource block and MCS (Modulation and Coding Scheme)).

EMM and ECM State

In what follows, EPS Mobility Management (EMM) and EPS Connection Management (ECM) states will be described.

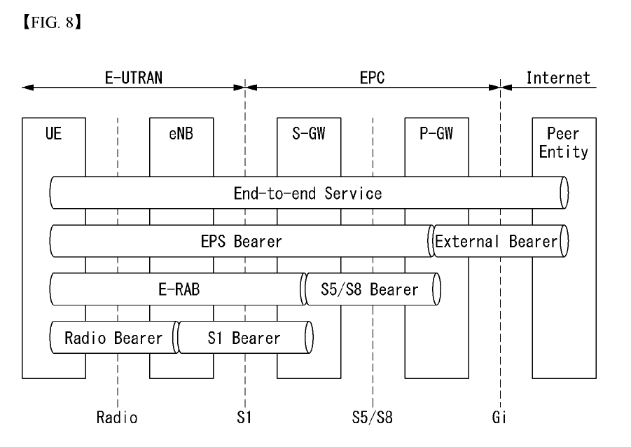

FIG. 7 illustrates an EMM and ECM states in a wireless communication system to which the present invention can be applied.

With reference to FIG. 7, to manage mobility of the UE in the NAS layer defined in the control planes of the UE and the MME, EMM-REGISTERED and EMM-DEREGISTERED states can be defined according to the UE is attached to or detached from a network. The EMM-REGISTERED and the EMM-DEREGISTERED states can be applied to the UE and the MME.

Initially, the UE stays in the EMM-DEREGISTERED state as when the UE is first powered on and performs registering to a network through an initial attach procedure to connect to the network. If the connection procedure is performed successfully, the UE and the MME makes transition to the EMM-REGISTERED state. Also, in case the UE is powered off or the UE fails to establish a radio link (namely, a packet error rate for a radio link exceeds a reference value), the UE is detached from the network and makes a transition to the EMM-DEREGISTERED state.

Similarly, to manage signaling connection between the UE and the network, ECM-CONNECTED and ECM-IDLE states can be defined. The ECM-CONNECTED and ECM-IDLE states can also be applied to the UE and the MME. ECM connection consists of RRC connection formed between the UE and the eNB; and S1 signaling connection formed between the eNB and the MME. In other words, establishing/releasing an ECM connection indicates that both of the RRC connection and S1 signaling connection have been established/released.

The RRC state indicates whether the RRC layer of the UE is logically connected to the RRC layer of the eNB. In other words, in case the RRC layer of the UE is connected to the RRC layer of the eNB, the UE stays in the RRC_CONNECTED state. If the RRC layer of the UE is not connected to the RRC layer of the eNB, the UE stays in the RRC_IDLE state.

The network can identify the UE staying in the ECM-CONNECTED state at the level of cell unit and can control the UE in an effective manner.

On the other hand, the network is unable to know the existence of the UE staying in the ECM-IDLE state, and a Core Network (CN) manages the UE on the basis of a tracking area unit which is an area unit larger than the cell. While the UE stays in the ECM-IDLE state, the UE performs Discontinuous Reception (DRX) that the NAS has configured by using the ID allocated uniquely in the tracking area. In other words, the UE can receive a broadcast signal of system information and paging information by monitoring a paging signal at a specific paging occasion for each UE-specific paging DRX cycle.

When the UE is in the ECM-IDLE state, the network does not carry context information of the UE. Therefore, the UE staying in the ECM-IDLE state can perform a mobility-related procedure based on the UE such as cell selection or cell reselection without necessarily following an order of the network. In case the location of the UE differs from the location recognized by the network while the UE is in the ECM-IDLE state, the UE can inform the network of the corresponding location of the UE through a Tracking Area Update (TAU) procedure.

On the other hand, when the UE is in the ECM-CONNECTED state, mobility of the UE is managed by an order of the network. While the UE stays in the ECM-CONNECTED state, the network knows to which cell the UE currently belongs. Therefore, the network can transit and/or receiver data to or from the UE, control mobility of the UE such as handover, and perform cell measurement with respect to neighboring cells.

As described above, the UE has to make a transition to the ECM-CONNECTED state in order to receive a general mobile communication service such as a voice or data communication service. As when the UE is first powered on, the UE in its initial state stays in the ECM-IDLE state as in the EMM state, and if the UE successfully registers to the corresponding network through an initial attach procedure, the UE and the MEE make a transition to the ECM connection state. Also, in case the UE has already registered to the network but radio resources are not allocated as traffic is not activated, the UE stays in the ECM-IDLE state, and if new uplink or downlink traffic is generated for the corresponding UE, the UE and the MME make a transition to the ECM-CONNECTED state through a Service Request procedure.

EPS Bearer

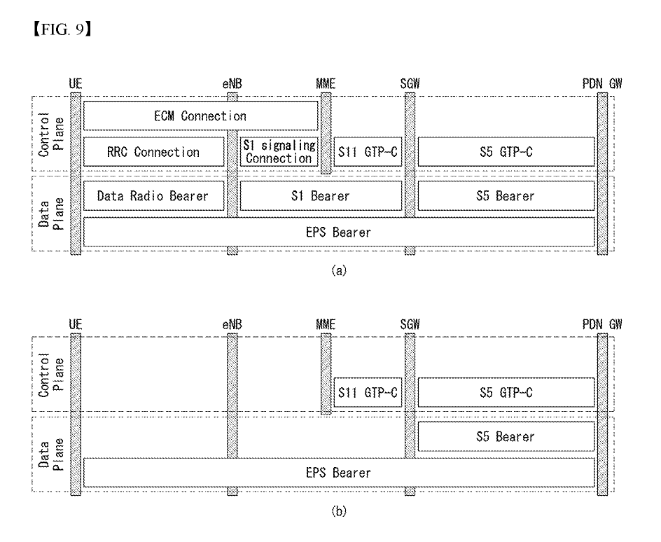

FIG. 8 illustrates a bearer structure in a wireless communication system to which the present invention can be applied.

When the UE is connected to a Packet Data Network (PDN) (which is the peer entity of FIG. 8), PDN connection is established, which can be called an EPS session. The PDN provides a service function such as the Internet or IP Multimedia Subsystem (IMS) through an external or internal IP network of the service provider.

An EPS session comprises one or more EPS bearers. The EPS bearer refers to the transmission path of traffic generated between the UE and the PDN GW for the EPS to deliver user traffic. One or more EPS bearers can be set up for each UE.

Each EPS bearer can be classified into E-UTRAN Radio Access Bearer (E-RAB) or S5/S8 bearer, and the E-RAB can be further divided into a Radio Bearer (RB) and S1 bearer. In other words, one EPS bearer corresponds to one RB, one S1 bearer, and one S5/S8 bearer.

The E-RAB delivers packets of the EPS bearer between the UE and the EPC. If an E-RAB is generated, the E-RAB bearer is one-to-one mapped to the EPS bearer. A Data Radio Bearer (DRB) delivers packets of the EPS bearer between the UE and the eNB. If a DRB is generated, it is one-to-one mapped to the EPS bearer/E-RAB. The S1 bearer delivers packets of the EPS bearer between the eNB and the S-GW. The S5/S8 bearer delivers EPS bearer packets between the S-GW and the P-GW.

The UE binds the EPS bearer in the uplink direction with a Service Data Flow (SDF). An SDF is a group of IP flow(s) obtained by classifying (or filtering) user traffic according to individual services. A plurality of SDFs can be multiplexed to the same EPS bearer by including a plurality of uplink packet filters. The UE stores mapping information between the uplink packet filter and the DRB to bind the SDF and the DRB with each other for uplink transmission.

The P-GW binds the SDF with the EPS bearer in the downlink direction. A plurality of SDFs can be multiplexed to the same EPS bearer by including a plurality of downlink packet filters. The P-GW stores mapping information between the downlink packet filter and the S5/S8 bearer to bind the SDF and the S5/S8 bearer with each other for downlink transmission.

The eNB stores one-to-one mapping information between the DRB and the S1 bearer to bind the DRB and the S1 bearer with each other. The S-GW stores one-to-one mapping information between the S1 bearer and the S5/S8 bearer to bind the S1 bearer and the S5/S8 bearer with each other for uplink/downlink transmission.

The EPS bearer can be one of two types: a default bearer and a dedicated bearer. The UE can have one default bearer and one or more dedicated bearers for each PDN. The minimum basic bearer that the EPS session can have with respect to one PDN is called default bearer.

The EPS bearer can be classified on the basis of its identity. The EPS bearer identity is allocated by the UE or the MME. The dedicated bearer(s) is combined with the default bearer by a Linked EPS Bearer Identity (LBI).

If the UE establishes an initial connection to the network through an initial attach procedure, an IP address is allocated to the UE to generate a PDN connection, and a default bearer is generated in the EPS interval. Unless the UE terminates the PDN connection, the default bearer is not released but maintained even when there is no traffic between the UE and the corresponding PDN; the default bearer is released when the corresponding PDN connection is terminated. At this time, not all the bearers acting as default bearers with respect to the UE across the whole interval are not activated; the S5 bearer connected directly to the PDN is maintained, and the E-RAB bearer related to radio resources (namely, DRB and S1 bearer) is released. And if new traffic is generated in the corresponding PDN, the E-RAB bearer is reconfigured to deliver traffic.

If the UE attempts to use a service of which the Quality of Service (QoS) (for example, Video on Demand (VoD) service) cannot be supported by the default bearer while using a service (for example, the Internet) through the default bearer, a dedicated bearer is created when the UE demands the high QoS service. In case there is no traffic from the UE, the dedicated bearer is released. The UE or the network can create a plurality of dedicated bearers depending on needs.

Depending on which service the UE uses, the IP flow can have different QoS characteristics. When the EPS session for the UE is established or modified, the network allocates network resources; or determines a control policy about QoS and applies the policy while the EPS session is maintained. The aforementioned operation is called Policy and Charging Control (PCC). A PCC rule is determined based on the operation policy (for example, a QoS policy, gate status, and charging method).

The PCC rule is determined in SDF unit. In other words, according to the service that the UE uses, the IP flow can have different QoS characteristics, IP flows having the same QoS are mapped to the same SDF, and the SDF becomes the unit by which the PCC rule is applied.

Main entities which perform the PCC function include a Policy and Charging Rules Function (PCRF) and Policy and Charging Enforcement Function (PCEF).

The PCRF determines a PCC rule for each SDF when the EPS session is established or modified and provides the PCC rule to the P-GW (or PCEF). After determining a PCC rule for the corresponding SDF, the P-GW detects the SDF for each IP packet transmitted or received and applies the PCC rule relevant to the corresponding SDF. When the SDF is transmitted to the UE via the EPS, the SDF is mapped to the EPS bearer capable of providing appropriate QoS according to the QoS rule stored in the P-GW.

PCC rules can be classified by dynamic PCC rules and pre-defined PCC rules. A dynamic PCC rule is provided dynamically from the PCRF to the P-GW when the EPS session is established or modified. On the other hand, a pre-defined PCC rule is predefined in the P-GW and activated/deactivated by the PCRF.

The EPS bearer includes a QoS Class Identifier (QCI) and Allocation and Retention Priority (ARP) as basic QoS parameters.

A QCI is a scalar used as a reference for accessing node-specific parameters which control bearer level packet forwarding treatment, where the scalar value is pre-configured by a network operator. For example, the scalar can be pre-configured by one of integer values ranging from 1 to 9.

The main purpose of the ARP is to determine whether a request for an establishment or modification of a bearer can be accepted or refused when only limited amount of resources are available. Also, the ARP can be used for the eNB to determine which bearer(s) to drop under the situation of limited resources (for example, handover).

EPS bearers can be classified to Guaranteed Bit Rate (GBR)-type bearers and non-GBR type bearers depending on QCI resource type. A default bearer is always a non-GBR type bearer, but a dedicated bearer can be a GBR or non-GBR type bearer.

A GBR-type bearer has GBR and Maximum Bit Rate (MBR) as QoS parameters in addition to the QCI and the ARP. The MBR indicates that fixed resources are allocated (bandwidth is guaranteed) for each bearer. On the other hand, a non-GBR type bearer has an Aggregated MBR (AMBR) as a QoS parameter in addition to the QCI and the ARP. The AMBR indicates that instead of allocating resources to individual bearers, maximum bandwidth is allocated, where other non-GBR type bearers can be used together.

As described above, if QoS of the EPS bearer is determined, QoS of each bearer is determined for each interface. Since the bearer of each interface provides QoS of the EPS bearer according to the interface, the EPS bearer, RB, and S1 bearer all have a one-to-one relationship among them.

If the UE attempts to use a service of which the QoS cannot be supported by the default bearer while using a service through the default bearer, a dedicated bearer is created.

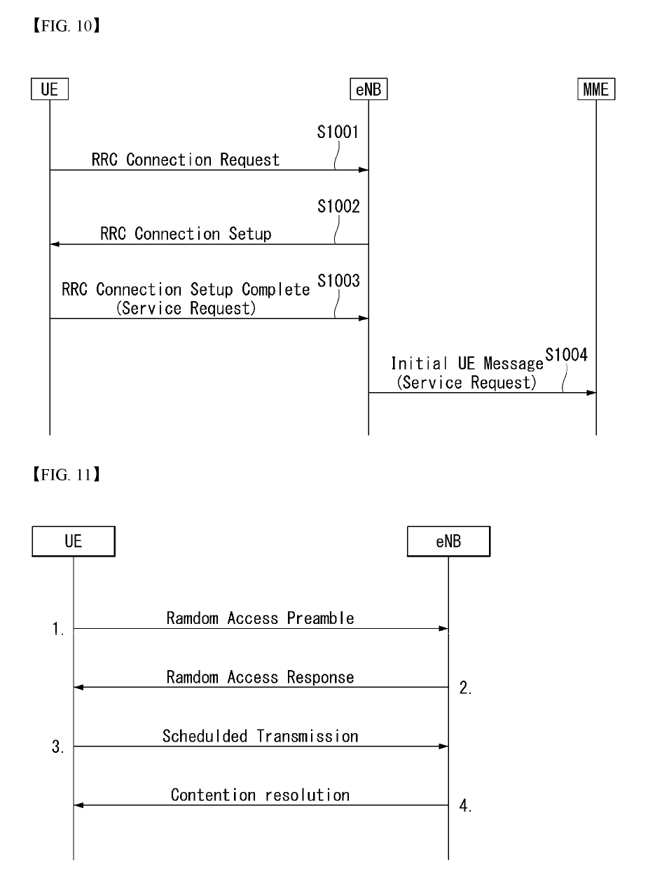

FIG. 9 illustrates transmission paths of a control plane and a user plane in an EMM registration state in a wireless communication system to which the present invention can be applied.

FIG. 9(a) illustrates ECM-CONNECTED state, and FIG. 9(b) illustrates ECM-IDLE state.

If the UE successfully attaches to the network and enters the EMM-Registered state, the UE receives a service by using an EPS bearer. As described above, the EPS bearer is divided into the DRB, S1 bearer, and S5 bearer according to the respective intervals.

As shown in FIG. 9(a), in the ECM-CONNECTED state where user traffic is present, NAS signaling connection, namely, ECM connection (RRC connection and S1 signaling connection) is established. Also, S11 GTP-C (GPRS Tunneling Protocol Control Plane) connection is established between the MME and the SGW, and S5 GTP-C connection is established between the SGW and the PDN GW.

Also, in the ECM-CONNECTED state, all of the DRB, S1 bearer, and S5 bearer are set up (namely, radio or network resources are allocated).

As shown in FIG. 9(b), in the ECM-IDLE state where there is no user traffic, the ECM connection (namely, RRC connection and S1 signaling connection) is released. However, the S11 GTP-C connection between the MME and the SGW; and the S5 GTP-C connection between the SGW and the PDN GW are retained.

Also, in the ECM-IDLE state, the DRB and the S1 bearer are all released, but the S5 bearer is retained (namely, radio or network resources are allocated).

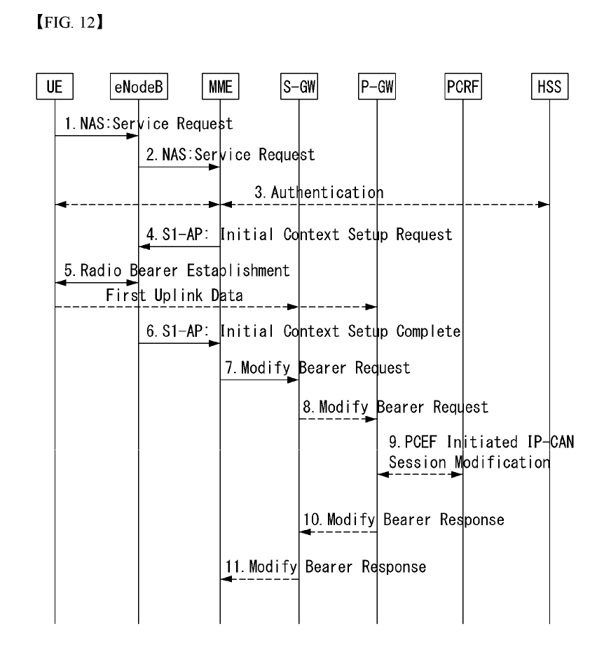

FIG. 10 illustrates an ECM connection establishment procedure in a wireless communication system to which the present invention may be applied.

Referring to FIG. 10, a UE transmits an RRC Connection Request message to an eNB to request an RRC connection S1001.

The RRC Connection Request message includes a UE Identity (for example, S-TMSI (SAE Temporary Mobile Subscriber Identity) or random ID) and an establishment cause.

The establishment cause is determined according to a NAS procedure (for example, attach, detach, tracking area update, service request, and extended service request).

The eNB transmits an RRC Connection Setup message to the UE in response to the RRC Connection Request message.

After receiving the RRC Connection Setup message, the UE transitions to the RRC_CONNECTED mode.

The UE transmits an RRC Connection Setup Complete message to the eNB to confirm successful completion of RRC connection establishment S1003.

The UE includes a NAS message (for example, an Initial Attach message and a Service Request message) in the RRC Connection Setup Complete message and transmits the RRC Connection Setup Complete message to the eNB.

The eNB obtains a Service Request message from the RRC Connection Setup Complete message and delivers the obtained Service Request message to the MME by using an Initial UE message that is an S1AP message S1004.

A control signal between the eNB and the MME is delivered through the S1AP message at the S1-MME interface. The S1AP message is delivered through an S1 signaling connection for each user, and the S1 signaling connection is defined by an allocated identity pair (namely eNB UE S1AP ID and MME UE S1AP ID) for the eNB and the MME to identify the UE.

The eNB allocates the eNB UE S1AP ID, includes it in the Initial UE message, and transmits the Initial UE message to the MME. The MME receives the Initial UE message, allocates the MME UE S1AP UE_ID, and establishes an S1 signaling connection between the eNB and the MME.

Random Access Procedure

In what follows, a random access procedure provided by the LTE/LTE-A system will be described.

A UE employs the random access procedure to obtain uplink synchronization with an eNB or to have uplink radio resources. After being powered up, the UE acquires downlink synchronization with an initial cell and receives system information. From the system information, the UE obtains a set of available random access preambles and information about a radio resource used for transmission of a random access preamble. The radio resource used for transmission of a random access preamble may be specified by a combination of at least one or more subframe indices and indices on the frequency domain. The UE transmits a random access preamble selected in a random fashion from the set of random access preambles, and the eNB receiving the random access preamble transmits a TA (Timing Alignment) value for uplink synchronization through a random access response. By using the procedure above, the UE obtains uplink synchronization.

The random access procedure is common to FDD (Frequency Division Duplex) and TDD (Time Division Duplex) scheme. The random access procedure is independent of a cell size and is also independent of the number of serving cells in case CA (Carrier Aggregation) is configured.

First, a UE performs the random access procedure in the following cases.
The case in which a UE performs initial access in an RRC idle state in the absence of an RRC connection to an eNB
The case in which a UE performs an RRC connection re-establishment procedure
The case in which a UE connects to a target cell for the first time while performing a handover procedure
The case in which a random access procedure is requested by a command from an eNB
The case in which downlink data are generated while uplink synchronization is not met in the RRC connected state
The case in which uplink data are generated while uplink synchronization is not met in the RRC connected state or a designated radio resource used for requesting a radio resource is not allocated
The case in which positioning of a UE is performed while timing advance is needed in the RRC connected state
The case in which a recovery process is performed at the time of a radio link failure or handover failure

The 3GPP Rel-10 specification takes into account applying a TA (Timing Advance) value applicable to one specific cell (for example, P cell) commonly to a plurality of cells in a wireless access system. However, a UE may combine a plurality of cells belonging to different frequency bands (namely separated with a large distance in the frequency domain) or a plurality of cells having different propagation characteristics. Also, in the case of a specific cell, if the UE performs communication with the eNB (namely macro eNB) through one cell and performs communication with the SeNB through other cell while a small cell such as an RRH (Remote Radio Header) (namely repeater), femto-cell, or pico-cell or a secondary eNB (SeNB) is disposed within the cell for coverage expansion or removal of a coverage hole, a plurality of cells may have different propagation delays. In this case, when the UE performs uplink transmission so that one TA value is applied commonly to a plurality of cells, synchronization of uplink signals transmitted among the plurality of cells may be seriously influenced. Therefore, it may be preferable to have multiple TA values under the CA mode in which a plurality of cells are aggregated. The 3GPP Rel-11 specification takes into account allocating a TA value separately for each specific cell group to support multiple TA values. This is called a TA group (TAG); a TAG may have one or more cells, and the same TA value may be applied commonly to one or more cells belonging to the TAG. To support the multiple TA values, a MAC TA command control element is composed of a 2-bit TAG Identity (ID) and a 6-bit TA command field.

A UE configured for carrier aggregation performs a random access procedure when the case of performing the random access procedure described above in connection with the PCell occurs. In the case of a TAG to which a PCell belongs (namely primay TAG (pTAG)), a TA value determined with respect to the PCell in the same way as existing methods or adjusted through a random access procedure in association with the PCell may be applied to all of the cells belonging to the pTAG. On the other hand, in the case of a TAG consisting of only SCells (namely secondary TAG (sTAG)), a TA value determined with respect to a specific SCell of the sTAG may be applied to all of the cells belonging to the corresponding sTAG. At this time, the TA value is determined from the random access procedure initiated by the eNB. More specifically, an SCell within an sTAG is designated as a RACH resource, and the eNB requests a RACH connection from the SCell to determine the TA value. In other words, the eNB initiates RACH transmission on the SCells according to a PDCCH order transmitted from the PCell. A response message with respect to an SCell preamble is transmitted through the PCell by using an RA-RNTI. The UE may apply the TA determined with respect to the SCell which has successfully completed random access to all of the cells belonging to the corresponding sTAG. In this manner, the random access procedure may be performed even in an SCell to acquire timing alignment of an sTAG to which the corresponding SCell belongs.

In a process of selecting a random access preamble (RACH preamble), the LTE/LTE-A system supports both of a contention based random access procedure and a non-contention based random access procedure. In the former procedure, a UE selects one arbitrary preamble from a specific set, while, in the latter procedure, the UE uses the random access preamble that an eNB has allocated only to the specific UE. It should be noted, however, that the non-contention based random access procedure may be confined to the handover process described above, a case requested by a command from the eNB, and UE positioning and/or timing advance alignment for sTAG. After the random access procedure is completed, a normal uplink/downlink transmission occurs.

Meanwhile, a relay node (RN) also support both of the contention based random access procedure and the non-contention based random access procedure. When a relay node performs the random access procedure, RN subframe configuration is suspended. That is, this means that the RN subframe configuration is temporarily discarded. Thereafter, the RN subframe structure is resumed at the time when the random access procedure is successfully completed.

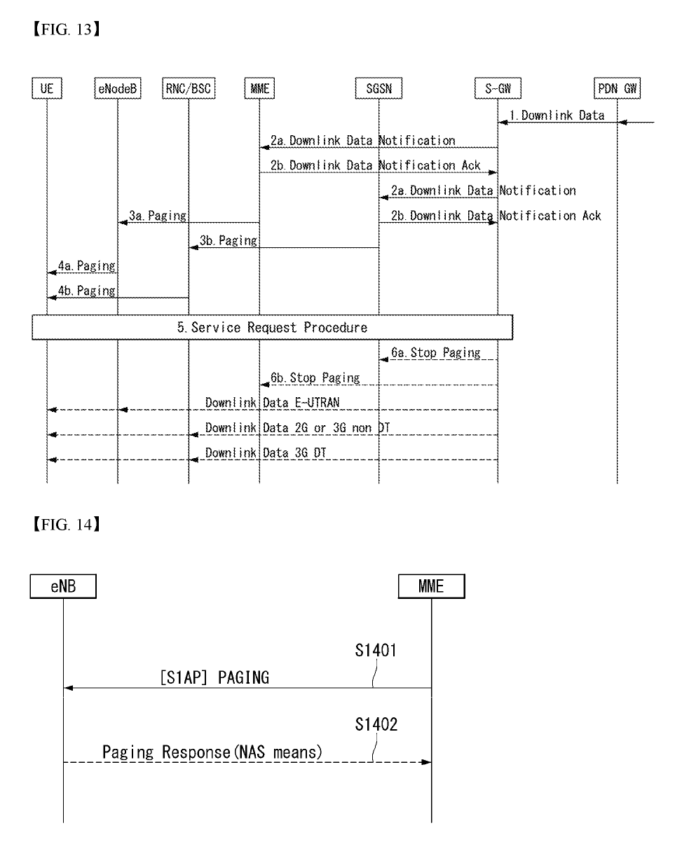

FIG. 11 illustrates a contention-based random access procedure in a wireless communication system to which the present invention may be applied.

(1) Msg 1 (Message 1)

First, a UE selects one random access preamble (RACH preamble) randomly from a set of random access preambles indicated by system information or a handover command. The UE then selects a PRACH (Physical RACH) resource capable of transmitting the random access preamble and transmits the random access preamble by using the PRACH resource.

A random access preamble is transmitted in six bits on the RACH transmission channel, where the six bit comprises a 5-bit random identity for identifying a UE which transmits a RACH preamble and 1 bit for representing additional information (for example, indicating size of Msg 3).

An eNB which has received a random access preamble from a UE decodes the preamble and obtains RA-RNTI. A time-frequency resource of a random access preamble transmitted by the corresponding UE determines the RA-RNTI related to a PRACH to which a random access preamble is transmitted.

(2) Msg 2 (Message 2)

The eNB transmits a random access response to the UE, where the RA-RNTI obtained by using the preamble on Msg 1 addresses the random access response. A random access response may include an RA preamble index/identifier, UL grant indicating a uplink radio resource, Temporary C-RNTI (TC-RNTI), and Time Alignment Command (TAC). A TAC indicates a time synchronization value that the eNB transmits to the UE to maintain uplink time alignment. The UE updates uplink transmission timing by using the time synchronization value. If the UE updates time synchronization, the UE initiates or restarts a time alignment timer. The UL grant includes uplink resource allocation and TPC (Transmit Power Command) used for transmitting a scheduling message (Msg 3) described later. The TPC is used to determine the transmission power for a scheduled PUSCH.

The UE attempts to receive a random access response within a random access response window indicated by the eNB through system information or a handover command, detects a PDCCH masked with an RA-RNTI corresponding to the PRACH, and receives a PDSCH indicated by the detected PDCCH. The random access response information may be transmitted in the form of a MAC PDU (MAC Packet Data Unit) and the MAC PDU may be transmit through the PDSCH. It is preferable that the PDCCH should include information of the UE that has to receive the PDSCH, frequency and time information of a radio resource of the PDSCH, and transmission format of the PDSCH. As described above, once the UE succeeds to detect the PDCCH transmitted to itself, it may properly receive a random access response transmitted to the PDSCH according to the information of the PDCCH.

The random access response window refers to a maximum time interval in which the UE transmitting a preamble waits to receive a random access response message. The random access response window has a length of ‘ra-ResponseWindowSize’ starting from a subframe after three subframes in the last subframe transmitting a preamble. In other words, the UE waits to receive a random access response during a random access window secured after three subframes from the subframe completed transmission of the preamble. The UE may obtain the random access window size (‘ra-ResponseWindowsize’) parameter through system information, and the random access window size is determined to be a value between 2 to 10.

If receiving a random access response having the same random access preamble delimiter/identity as that of the random access preamble transmitted to the eNB, the UE stops monitoring the random access response. On the other hand, if failing to receive a random access response message until a random access response window is terminated or failing to receive a valid random access response having the same random access preamble identity as that of the random access preamble transmitted to the eNB, the UE may consider reception of the random access response as having failed and then perform retransmission of the preamble.

As described above, the reason why a random access preamble identity is needed for a random access response is that one random access response may include random access response information for one or more UEs and thus it is necessary to indicate to which UE the UL grant, TC-RNTI, and TAC is valid.

(3) Msg 3 (Message 3)

Receiving a valid random access response, the UE separately processes the information included in the random access response. In other words, the UE applies the TAC and stores the TC-RNTI. Also, by using the UL grant, the UE transmits the data stored in its buffer or newly generated data to the eNB. In case the UE is connected for the first time, an RRC Connection request generated at the RRC layer and transmitted through a CCCH may be included in the Msg 3 and transmitted. And in the case of an RRC Connection Re-establishment procedure, an RRC Connection Re-establishment request generated at the RRC layer and transmitted through the CCCH may be included in the Msg 3 and transmitted. Also, a NAS connection request message may be included in the Msg 3.

The Msg 3 has to include a UE identity. In the case of a contention based random access procedure, the eNB is unable to determine which UEs perform the random access procedure. Thus, the eNB needs the UE identity for each UE to avoid potential contention.

There are two methods for including UE identities. In the first method, if the UE already has a valid cell identity (C-RNTI) allocated by the corresponding cell before performing the random access procedure, the UE transmits its cell identity though a uplink transmission signal corresponding to the UL grant. On the other hand, if the UE has not received a valid cell identity before performing the random access procedure, the UE transmits its unique identity (for example, S-TMSI or a random number). In most cases, the unique identity is longer than the C-RNTI.

The UE uses UE-specific scrambling for transmission on UL-SCH. In case the UE has received a C-RNTI, the UE may perform scrambling by using the C-RNTI. In case the UE has not received a C-RNTI yet, the UE is unable to perform C-RNTI based scrambling but uses a TC-RNTI received from a random access response instead. If having received data corresponding to the UL grant, the UE initiates a contention resolution timer for resolving contention.

(4) Msg 4 (Message 4)

Receiving the C-RNTI of a UE through the Msg 3 from the corresponding UE, the eNB transmits a Msg 4 to the UE by using the receiving C-RNTI. On the other hand, in case the eNB receives the unique identity (namely S-TMSI or a random number) through the Msg 3, the eNB transmit the Msg 4 to the UE by using a TC-RNTI allocated to the corresponding UE from a random access response. As one example, the Msg 4 may include an RRC Connection Setup message.

After transmitting data including an identity through a UL grant included in the random access response, the UE waits for a command from the eNB to resolve contention. In other words, two methods are available for a method for receiving the PDCCH, too. As described above, in case the identity in the Msg 3 transmitted in response to the UL grant is the C-RNTI, the UE attempts to receive the PDCCH by using its C-RNTI. In case the identity is a unique identity (in other words, S-TMSI or a random number), the UE attempts to receive the PDCCH by using the TC-RNTI included in the random access response. Afterwards, in the former case, if the UE receives the PDCCH though its C-RNTI before the contention resolution timer expires, the UE determines that the random access procedure has been performed normally and terminates the random access procedure. In the latter case, if the UE receives the PDCCH through the TC-RNTI before the contention resolution timer is completed, the UE checks the data transmitted by the PDSCH indicated by the PDCCH. If the data includes a unique identity of the UE, the UE determines that the random access procedure has been performed successfully and terminates the random access procedure. The UE obtains the C-RNTI through the Msg 4, after which the UE and the network transmit and receive a UE dedicated message by using the C-RNTI.

Next, a method for resolving contention during random access will be described.

The reason why contention occurs during random access is that the number of random access preambles is, in principle, finite. In other words, since the eNB is unable to assign random access preambles unique to the respective UEs, a UE selects and transmits one from among common random access preambles. Accordingly, although there are cases where two or more UEs select and transmit the same random access preamble by using the same radio resource (PRACH resource), the eNB considers the random access preamble as the one transmitted from a single UE. Thus, the eNB transmits a random access response to the UE and expects that only one UE receive the random access response. However, as described above, because of the possibility of contention, two or more UEs receive the same random access response, and each receiving UE performs an operation due to the random access response. In other words, a problem occurs where two or more UEs transmit different data to the same radio resource by using one UL grant included in the random access response. Accordingly, transmission of the data may all fail, or the eNB may succeed to receive only the data from a specific UE depending on the positions of transmission power of UEs. In the latter case, since two or more UEs assume that they all have succeeded to transmit their data, the eNB has to inform those UEs that have failed in the contention about their failure. In other words, contention resolution refers to the operation of informing a UE about whether it has succeeded or failed.

Two methods are used for contention resolution. One of the methods employs a contention resolution timer and the other method employs transmitting an identity of a successful UE to other UEs. The former case is used when a UE already has a unique C-RNTI before performing a random access process. In other words, a UE that already has a C-RNTI transmits data including its C-RNTI to the eNB according to a random access response and operates a contention resolution timer. And if the UE receives a PDCCH indicated by its C-RNTI before the contention resolution timer expires, the UE determines that it has won the contention and finishes random access normally. On the other hand, if the UE fails to receive a PDCCH indicated by its C-RNTI before the contention resolution timer expires, the UE determines that it has lost the contention and performs the random access process again or inform a upper layer of the failure. The latter contention resolution method, namely the method for transmitting an identity of a successful UE, is used when a UE does not have a unique cell identity before performing the random access process. In other words, in case the UE has no cell identity, the UE transmits data by including an upper identity (S-TMSI or a random number) higher than a cell identity in the data according to the UL grant information included in a random access response and operates a contention resolution timer. In case the data including the upper identity of the UE is transmitted to a DL-SCH before the contention resolution timer expires, the UE determines that the random access process has been performed successfully. On the other hand, in case the data including the upper identity of the UE is not transmitted to the DL-SCH before the contention resolution data expires, the UE determines that the random access process has failed.

Meanwhile, different from the contention based random access process illustrated in FIG. 11, a non-contention based random access process finishes its procedures only by transmitting the Msg 1 and 2. However, before the UE transmits a random access preamble to the eNB as the Msg 1, the eNB allocates a random access preamble to the UE. The random access procedure is terminated as the UE transmits the allocated random access preamble to the eNB as the Msg 1 and receives a random access response from the eNB.

Service Request Procedure

For most cases, the UE-triggered Service Request procedure is used when the UE initiates a new service or attempts.

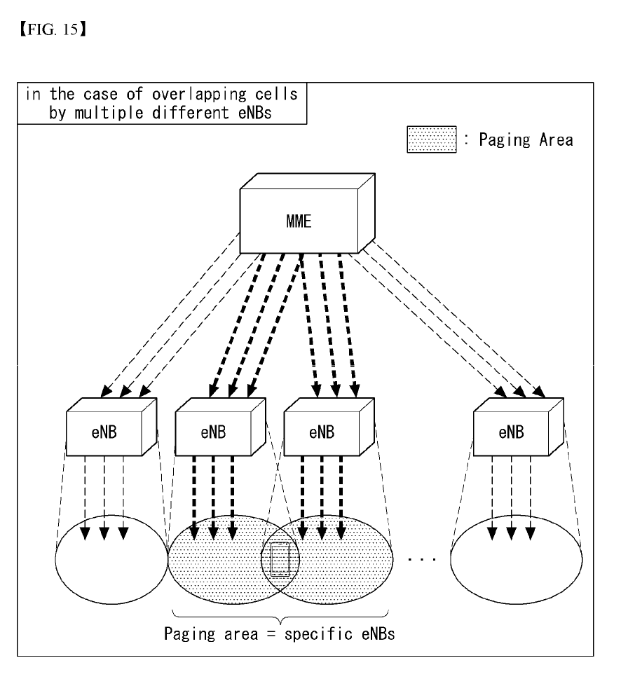

FIG. 12 illustrates a UE trigger Service Request procedure in a wireless communication system to which the present invention can be applied.

1-2. The UE initiates a UE-triggered Service Request procedure by transmitting a Service Request message to the MME.

The Service Request message is delivered being included in an RRC connection setup complete message through the RRC connection and delivered being included in an initial UE message through the S1 signaling connection.

3. For authentication of the UE, the MME requests and receives information for the authentication from the HSS; and performs mutual authentication with the UE.

4. The MME transmits an Initial Context Setup Request message to the eNB so that the eNB can configure an S1 bearer with the S-GW and configure a DRB with the UE.

5. The eNB transmits an RRC Connection Reconfiguration message to the UE to create the DRB.

When this procedure is done, the creation of DRB is completed between the eNB and the UE, and all of uplink EPS bearers ranging from the UE to the P-GW are configured. The UE can transmit uplink traffic data to the P-GW.

6. The eNB transmits an Initial Context Setup Complete message including ‘S1 eNB TEID’ to the MME in response to the Initial Context Setup Request message.

7. The MME delivers the ‘S1 eNB TEID’ received from the eNB to the S-GW through a Modify Bearer Request message.

When this procedure is done, the creation of S1 bearer is completed between the eNB and the S-GW, and then all of the downlink EPS bearers ranging from the P-GW and the UE are configured. The UE can then receive downlink traffic data from the P-GW.

8. In case the cell (ECGI) or the tracking area (TAI) in which the UE is located changes, the S-GW transmits the Modify Bearer Request message to the P-GW.

9. If needed, the P-GW can perform an IP connectivity access network (IP-CAN) session modification procedure with the PCRF.

10. Receiving a Modify Bearer Request message from the S-GW, the P-GW transmits a Modify Bearer Response message to the S-GW in response to the message.

11. The S-GW transmits a Modify Bearer Response message to the MME in response to the Modify Bearer Request message.

A network-triggered Service Request procedure is usually performed when the network attempts to transmit downlink data to the UE staying in the ECM-IDLE state.

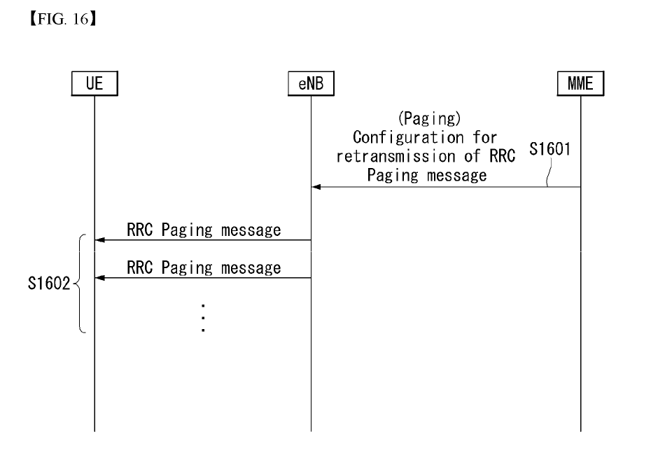

FIG. 13 illustrates a Network trigger Service Request procedure in a wireless communication system to which the present invention can be applied.

1. If downlink data arrives at the P-GW via an external network, the P-GW delivers downlink data to the S-GW.

2. In case the downlink S1 bearer is released (i.e., ECM-IDLE state) and unable to transmit downlink data to the eNB (namely, in case ‘S1 eNB TEID’ value is not found in the S-GW), the S-GW buffers the received downlink data. And the S-GW transmits a Downlink Data Notification message to the MME/SGSN to which the UE is registered for signaling connection and bearer configuration with respect to the corresponding UE.

The MME/SGSN transmits a Downlink Data Notification ACK message to the S-GW in response to the Downlink Data Notification message.

3. The MME transmits a paging message to all the eNB/RNC(or Base Station Controller (BSC)) belonging to the tracking area to which the UE has most recently registered.

4. If the eNB/RNC(or BSC) receives a paging message from the MME/SGSN, the eNB/RNC(or BSC) broadcasts the paging message.

5. The UE, noticing the existence of downlink data directed to itself, sets up an ECM connection by performing a Service Request procedure. That is, in this case, the service request procedure is initiated by paging sent from the network.

The Service Request procedure can be performed in the same way as the procedure of FIG. 12, and if the procedure is completed, the UE can receive downlink data from the S-GW.

6. If receiving a paging response, the S-GW transmits a “Stop Paging” message to the MME/SGSN.

If the MME/SGSN commands the eNB/RNC (or BSC) or cells to perform paging transmission, the eNB/RNC (or BSC) calculates a paging occasion through the IMSI value and DRX cycle of the UE and transmits a paging message at the corresponding paging occasion. In case there is no response from the UE for a specific time period with respect to the paging transmission, the MME may consider the situation as a paging transmission failure and command the eNB/RNC (or BSC) or cells to perform paging retransmission.

In other words, the MME determines paging retransmission when the MME fails to receive a service request from the UE; the eNB does not supervise paging reception or perform paging retransmission. In case the MME transmits a paging message to a large number of cells, the UE transmits a service request while belonging to one of the cells; therefore, if there is no response to the paging message, the eNB may determine that the corresponding UE does not belong to the cell of the eNB.

Meanwhile in case the MME/SGSN does not receive a response from the UE after the paging repetition/retransmission procedure, the MME/SGSN notifies the S-GW of a paging failure by using a Downlink Data Notification Reject message.

Receiving the Downlink Data Notification Reject message, the S-GW may delete a buffered packet(s).

Paging

The paging procedure in a network is used to transmit paging information to a UE in the RRC_IDLE mode, notify a UE in the RRC_IDLE/RRC_CONNECTED mode of change of system information, notify a UE in the RRC_IDLE/RRC_CONNECTED mode of ETWS primary notification and/or ETWS secondary notification, or notify a UE in the RRC_IDLE/RRC_CONNECTED mode of CMAS notification.

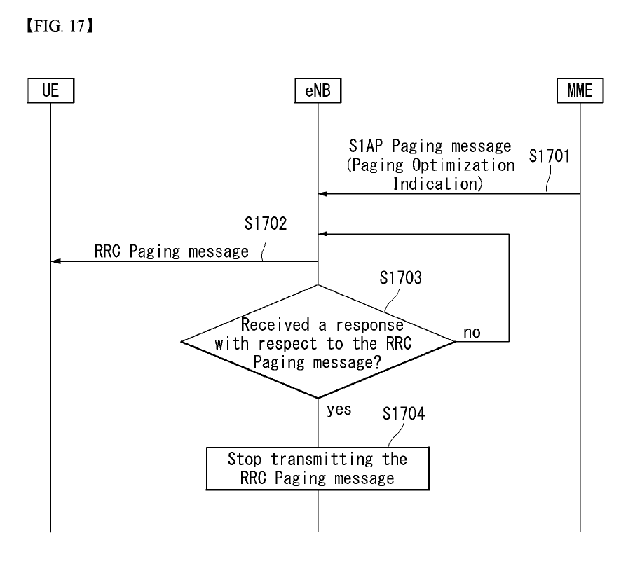

FIG. 14 illustrates a paging procedure in a wireless communication system to which the present invention may be applied.

Referring to FIG. 14, the MME initiates the paging procedure by transmitting a paging message to the eNB S1401.

As described above, the MME manages the location of a UE in the ECM-IDLE state on the basis of a Tracking Area (TA). At this time, since the UE may be registered to one or more TAs, the MME may transmit a paging message to a plurality of eNBs covering a cell belonging to the TA(s) to which the UE is registered. Here, each cell may belong to only one TA, and each eNB may include cells belonging to different TAs.

Here, the MME transmits a paging message to each eNB through the S1AP interface (or S1AP protocol). In what follows, the paging information may be called a ‘S1AP paging message’ (or paging request).

A paging response to the MME is initiated at the NAS layer and may be transmitted by the eNB on the basis of NAS-level routing information S1402.

In other words, the paging response may correspond to a Service Request NAS message transmitted from the UE. As illustrated in FIG. 10, the UE may transmit the Service Request NAS message to the eNB by including the message in the RRC Connection Setup Complete message, and the eNB may transmit the message to the MME by including the message in the Initial UE message.

Table 2 illustrates the S1AP paging message.

TABLE 2

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | ignore |
| UE Identity Index | M | | 9.2.3.10 | | YES | ignore |
| value | | | | | | |
| UE Paging Identity | M | | 9.2.3.13 | | YES | ignore |
| Paging DRX | O | | 9.2.1.16 | | YES | ignore |
| CN Domain | M | | 9.2.3.22 | | YES | ignore |
| List of TAIs | | 1 | | | YES | ignore |
| >TAI List Item | | 1 . . . <maxnoofTAIs> | | | EACH | ignore |
| >>TAI | M | | 9.2.3.16 | | — | |
| CSG Id List | | 0 . . . 1 | | | GLOBAL | ignore |
| >CSG Id | | 1 . . . <maxnoofCSGId> | 9.2.1.62 | | — | |
| Paging Priority | O | | 9.2.1.78 | | YES | ignore |

Referring to Table 2, IE/Group Name represents the name of an information element (IE) or IE group. ‘M’ in the Presence field refers to a mandatory IE and indicates an IE/IE group that is always included in a message. ‘O’ indicates an optional IE and refers to an IE/IE group that may or may not be included in a message. ‘C’ indicates a conditional IE and refers to an IE/IE group included in a message included only when a specific condition is met. The Range field represents the number of repetition of repetitive IEs/IE groups.

The IE type and reference field represents the type of the corresponding IE (for example, enumeration, integer, and octet string) and represents a range of values that the corresponding IE may have.

The Criticality field represents criticality information applied to the IE/IE group. The criticality information indicates how a receiving side should operate in case the receiving side does not understand the whole or part of the IE/IE group. ‘-’ symbol indicates that criticality information is not applied, while ‘YES’ indicates that criticality information is applied. ‘GLOBAL’ indicates that an IE and repetition of the corresponding IE have the same criticality information. ‘EACH’ indicates that each repetition of an IE has unique criticality information. The Assigned Criticality field represents actual criticality information.

In what follows, the IE or IE group included in the S1AP paging message will be described in more detail.

The Message Type IE identifies a transmitted message uniquely.

The UE Identity Index value IE is used for the eNB to calculate a Paging Frame (PF) (for example, UE Identity Index=UE IMSI mod 1024).

The UE Paging Identity IE is an Identity for identifying a paged UE and is indicated by one of IMSI and S-TMSI (SAE Temporary Mobile Subscriber Identity). The S-TMSI is an identity for identifying an UE uniquely within one MME group.

In the case of general paging, the S-TMSI is used as a UE paging identity. On the other hand, in case an IMSI is used as the UE paging identity, which is denoted as Paging with IMSI, the UE performs a re-attach procedure when it receives a paging message as the IMSI value.

The Paging DRX IE is used for the eNB to calculate the Paging Frame (PF) in case the UE uses a specific DRX cycle length. The UE may specify the DRX cycle length in an Attach Request message or Tracking Area Update (TAU) message.

The CN Domain IE indicates whether paging originates from a CS (Circuit Switched) domain or PS (Packet Switched) domain.

The Tracking Area Identity (TAI) List IE is used for informing the eNB of a TA over which a paging message has to be broadcast. The TAI refers to an identity used for identifying a TA uniquely.

The Closed Subscriber Group (CSG) ID List IE represents a CSG set to which the UE has subscribed. The CSG ID List IE prevents the eNB from paging a UE within a CSG cell to which the UE is not subscribed.

The eNB, which has received the S1AP paging message from the MME, constructs a paging message (in what follows, it is called an ‘RRC Paging message’ or paging information).

Table 3 illustrates the RRC Paging message.

TABLE 3

| | | | |
|---|---|---|---|
| -- ASN1START | | | |
| Paging ::= | SEQUENCE { | | |
| pagingRecordList | PagingRecordList | OPTIONAL, -- | |
| Need ON | | | |
| systernInfoModification | ENUMERATED {true} | | |
| OPTIONAL, -- Need ON | | | |
| etws-Indication | ENUMERATED {true} | OPTIONAL, | -- Need ON |
| nonCriticalExtension | Paging-v890-IEs | OPTIONAL -- | |
| Need OP | | | |
| } | | | |
| Paging-v890-IEs ::= | SEQUENCE { | | |
| lateNonCriticalExtension | OCTET STRING | OPTIONAL, | -- Need OP |
| nonCriticalExtension | Paging-v920-IEs | OPTIONAL | -- Need OP |
| } | | | |
| Paging-v920-IEs ::= | SEQUENCE { | | |
| cmas-Indication-r9 | ENUMERATED {true} | OPTIONAL, | -- Need ON |
| nonCriticalExtension | Paging-v1130-IEs | OPTIONAL -- | |
| Need OP | | | |
| } | | | |
| Paging-v1130-IEs ::= | SEQUENCE { | | |
| eab-ParamModification-r11 | ENUMERATED {true} | OPTIONAL, | -- Need ON |
| nonCriticalExtension | SEQUENCE { } | OPTIONAL | -- Need OP |
| } | | | |

| | |
|---|---|
| PagingRecordList ::= | SEQUENCE (SIZE (1..maxPageRec)) OF PagingRecord |
| PagingRecord ::= | SEQUENCE { |
| ue-Identity | PagingUE-Identity, |
| cn-Domain | ENUMERATED {ps, cs}, |
| ... | |
| } | |
| PagingUE-Identity ::= | CHOICE { |
| s-TMSI | S-TMSI, |
| imsi | IMSI, |
| ... | |
| } | |
| IMSI ::= | SEQUENCE (SIZE (6..21)) OF IMSI-Digit |
| IMSI-Digit ::= | INTEGER (0..9) |
| -- ASN1STOP | |

Referring to Table 3, a single RRC paging message may carry information of multiple S1AP paging messages. In other words, an RRC paging message may include multiple paging records (for example, 16) for paging multiple UEs.

Each paging record includes a UE Identity field and CN-Domain field. These fields are contents delivered by the S1AP paging message.

The systemInfoModification field is not delivered by the S1AP paging message but is generated by the eNB. This field is used to trigger the UE to re-acquire a System Information Block (SIB) set.

The Extended Access Barring (EAB)-ParamModification field is used to indicate modifying the EAB parameter (SIB 14).

The ETWS-Indication field is not delivered by the S1AP paging message but is generated by the eNB. This field is applied only to an ETWS capable UE and is used to trigger the corresponding UE to re-acquire SIB 1. The SIB 1 content indicates the ETWS content within the SIB 10 and SIB 11 for the UE.

The CMAS-Indication field is applied only to the CMAS capable UE that supports the CMAS and is used to trigger the corresponding UE to re-acquire SIB 1. The SIB 1 content indicates the CMAS content within the SIB 12 for the UE.

As described above, the eNB that has constructed the RRC paging message transmits downlink control information (DCI) to which a CRC (Cyclic Redundancy Check) scrambled with a P-RNTI (Paging-RNTI) is attached to the UE through the PDCCH and transmits an RRC paging message to the UE through the PDSCH.

In other words, the eNB transmits the RRC paging message to the UE through a PCCH logical channel, PCH transmission channel, and PDSCH physical channel.

More specifically, the eNB determines the PDCCH format according to the DCI to be transmitted to the UE and attaches a CRC to the DCI. The CRC is scrambled (or masked) with a unique RNTI (Radio Network Temporary Identifier) according to the owner or intended use of the PDCCH. In the case of a PDCCH for a specific UE, the CRC may be masked with a unique identifier of the UE (for example, C-RNTI (Cell-RNTI)) may be masked. Similarly, in the case of a PDCCH for a paging message, the CRC may be masked with a paging indication identifier (for example, P-RNTI (Paging-RNTI)).

In other words, the UE monitors the PDCCH by using the P-RNTI at the subframe belonging to the paging occasion of the UE. And if the UE detects a PDCCH masked with a P-RNTI, the UE decodes the DCI transmitted on the PDCCH. The DCI indicates a PDSCH resource to which a paging message is transmitted. And the UE decodes an RRC paging message from the PDSCH resource indicated by the DCI.

A paging cycle may be determined in a cell-specific manner or UE-specific manner. Also, the paging occasion is determined for each UE on the basis of the paging cycle and the identifier (namely IMSI) of the UE. Therefore, it is not the case that the eNB transmits a paging message to all of the UEs at a possible paging occasion. Instead, the eNB transmits a paging message according to the paging occasion of the corresponding UE. A more detailed description about the paging occasion will be given later.

A paging procedure may be used for notifying of change of system information, reception of a cell broadcast message (namely ETWS/CAMS warning message), and change of EAB parameter in addition to notification of reception of an MT (Mobile Terminated) call by each UE.

In case a UE identity (for example, IMSI or S-TMSI) is included in one of paging records belonging to an RRC paging message (in other words, the paging procedure is used for notification of an MT call), a UE in the RRC_IDLE mode initiates a random access procedure to establish an RRC connection to the network (for example, to transmit a Service Request).

Also, in case the RRC paging message includes systemInfoModification, the UE re-acquires required system information by using a system information acquisition procedure.

Also, in case ETWS-indication is included in the RRC paging message and the UE supports the ETWS, the UE re-acquires SIB 1 immediately. In other words, the UE does not wait until the next system information modification. And if a scheduling information list (schedulingInforList) belonging to the SIB 1 indicates existence of SIB 10, the UE acquires the SIB 10 by using scheduling information (schedulingInfor). Also, if the scheduling information list (schedulingInfoList) belonging to the SIB 1 indicates existence of SIB 11, the UE acquires the SIB 11 by using the scheduling information (schedulingInfor).

Also, in case a CMAS-Indication is included in the RRC paging message and the UE support the CMAS, the UE re-acquires the SIB 1 immediately. In other words, the UE does not wait until the next system information modification. And if a scheduling information list (schedulingInfoList) belonging to the SIB 1 indicates existence of SIB 12, the UE acquires the SIB 12 by using scheduling information (schedulingInfor).

As described above, in case an RRC paging message includes cell broadcast message (namely ETWS/CAMS message) indication, the UE receives SIB 10, SIB 11, and SIB 12 with reference to the schedulingInfoList of the SIB 1. The received SIB 10, SIB 11, and SIB 12 are transmitted to the upper layer of the UE (for example, RRC layer). In the upper layer of the UE, if a message identifier belonging to a cell broadcast message transmitted through the SIB 10, SIB 11, and SIB 12 is included in a search list of the UE, the message identifier is displayed on the UE, but discarded otherwise.

Also, in case a UE in the RRC_IDLE mode supports EAB and the RRC paging message includes an EAB parameter modification (eab-ParamModification) field, the UE considers that a previously stored SIB 14 is not valid and re-acquires SIB 1 immediately. In other words, the UE does not wait until the next system information modification. And the UE re-acquires SIB 14 by using the system information acquisition procedure.

In what follows, paging occasion will be described.

The 3GPP LTE/LTE-A system defines DRX (Discontinuous Reception) scheme for a UE to minimize power consumption.

A UE employing DRX monitors transmission of a paging message only at one paging occasion for each paging cycle (namely DRX cycle).

One paging fame (PF) refers to one radio frame that may include one or more paging occasion(s).

One paging occasion (PO) refers to one subframe having a P-RNTI transmitted on a PDCCH addressing a paging message. In other words, a paging occasion is defined as a specific subframe within a PF for which a UE checks a paging message.

A PF and a PO are determined from an IMSI and DRX value of the UE. The UE may calculate a PF and PO by using its IMSI and DRX value. Also, the eNB may also calculate a PF and PO for each UE by using the IMSI value received from the MME.

A DRX parameter (namely paging/PCCH configuration information) may be transmitted by being included in a common radio resource configuration (‘RadioResourceConfigCommon’) IE, which is an RRC message used for specifying common radio resource configuration. The common radio resource configuration IE may be transmitted through an RRC message such as an RRC Connection Reconfiguraiton message or SI message. An SI message is used for transmitting one or more SIBs.

Also, the UE may request its own DRX cycle through an Attach Request or TAU (Tracking Area Update Request) message. At this time, a DRX cycle length set that may be requested by the UE is the same as a length set used within the system information.

Table 4 illustrates PCCH configuration information within the common radio resource configuration IE.

TABLE 4

| | |
|---|---|
| PCCH-Config ::= | SEQUENCE { |
| defaultPagingCycle | ENUMERATED { |
| | rf32, rf64, rf128, rf256}, |
| nB | ENUMERATED { |
| | fourT, twoT, oneT, halfT, quarterT, |
| | oneEighthT, oneSixteenthT, |
| | oneThirtySecondT} |
| } | |

Referring to Table 4, PCCH configuration information includes a ‘defaultPagingCycle’ field indicating a default paging cycle length and a parameter ‘nB’ for acquiring a paging frame and a paging occasion.

The ‘defaultPagingCycle’ field may be set to one of {rf32, rf64, rf128, rf256} values for the default paging cycle length. Here, rf represents a radio frame, and the number subsequent to if represents the number of radio frames. For example, if ‘defaultPagingCycle’=rf32, the default paging cycle comprises 32 radio frames, while, if ‘defaultPagingCycle’=rf64, the default paging cycle comprises 64 radio frames.

The value of ‘nB’ parameter is specified by a multiple of ‘T’ (4T, 2T, T, T/2, T/4, T/8, T/16 or T/32). For example, if ‘nB’=fourT, the value of ‘nB’ parameter is 4*T while, if ‘nB’=quarterT, the value of ‘nB’ parameter is T/4.

Here, ‘T’ represents the DRX cycle of the UE. ‘T’ is determined by the shorter of a UE-specific DRX cycle (in case the DRX cycle is allocated by a upper layer) and the default DRX cycle (the ‘defaultPagingCycle’ field value) broadcast from the system information. In case the UE-specific DRX cycle is not set by the upper layer, it is determined as the default DRX cycle.

The PF is determined by Equation 1 below.

SFN mod T=(T div N)*(UE_ID mod N) [Equation 1]

In Equation 1, N represents min(T, nB), and UE_ID represents (IMSI mod 1024).

The UE does not monitor all of the subframes of the PF determined by Equation 1. Instead, the UE monitors only those subframes identified by Equation 2 and Table 5 (or Table 6) below.

i_s=floor(UE_ID/N)mod Ns [Equation 2]

In Equation 2, Ns represents max(1, nB/T).

Table 5 illustrates a subframe pattern for determining a PO in the FDD scheme.

TABLE 5

| | PO when | PO when | PO when | PO when |
|---|---|---|---|---|
| Ns | i_s = 0 | i_s = 1 | i_s = 2 | i_s = 3 |
| 1 | 9 | N/A | N/A | N/A |
| 2 | 4 | 9 | N/A | N/A |
| 4 | 0 | 4 | 5 | 9 |

Table 6 illustrates a subframe pattern for determining a PO in the TDD scheme.

TABLE 6

| | PO when | PO when | PO when | PO when |
|---|---|---|---|---|
| Ns | i_s = 0 | i_s = 1 | i_s = 2 | i_s = 3 |
| 1 | 0 | N/A | N/A | N/A |
| 2 | 0 | 5 | N/A | N/A |
| 4 | 0 | 1 | 5 | 6 |

The i_s value determined by Equation 2 above is applied to Table 5 and 6, and a subframe index corresponding to a PO is determined. In other words, the UE monitors only those subframes corresponding to the PO within the determined PF.

Paging Retransmission (or Repetition) Method

Since MTC (Machine Type Communication) is introduced as an important feature of the 3GPP standard, a need for standardizing paging optimization taking into account characteristics of MTC (M2M) devices is under discussion.

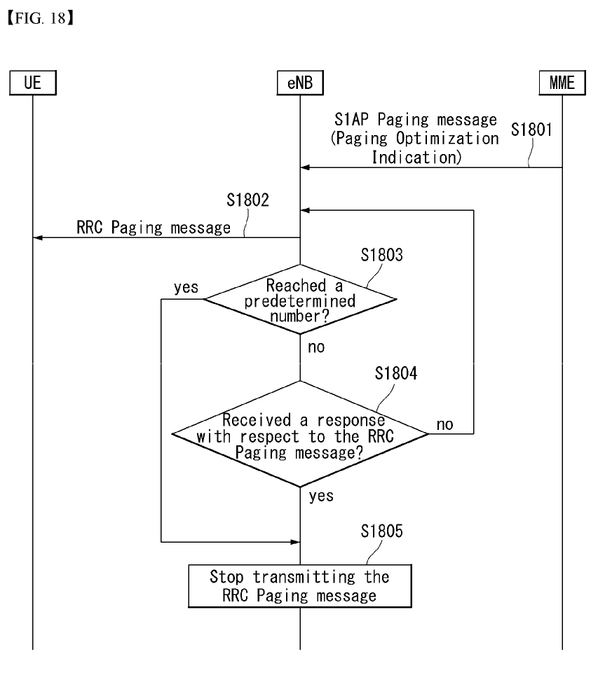

FIG. 15 illustrates one example of a paging method in a wireless communication system to which the present invention may be applied.

Referring to FIG. 15, when paging an MTC terminal showing a low mobility characteristic, a recently proposed method does not page all of the cells belonging to TAs (Tracking Areas). Instead, the method performs paging only the last used eNB where the location of a UE has been last reported and its overlapping eNBs. Since an MTC device operates in a stationary form, paging a large number of eNBs (or cells) as done for conventional terminals involving motions is inefficient. Moreover, when a large number of MTC devices are processed, paging resources readily become scarce, and thus a paging process for an existing voice service as well as the MTC devices may be affected. In this regard, the recent method is based on the idea that the MME stores the cell reported when the UE transitions from ECM-Connected to ECM-Idle mode or the cell updated through the Tracking Area Update (TAU). The MME then requests paging transmission only from the corresponding cell (namely last used cell) and overlapping cells when downlink data of the corresponding UE and signaling are transmitted.

Also, instead of using a method for operating and maintaining overlapping cells, a method for determining with respect to a cell to which the UE reports is proposed.

In the existing methods above, when the MME transmits paging to a specific cell or those cells overlapping with the specific cell by using a paging optimization method, the MME retransmits paging by extending the paging range to include all of the cells belonging to the tracking area (TA) if the MME determines that paging transmission has failed.

In the existing paging methods, the MME is the primary entity that determines whether paging transmission has failed and whether to perform retransmission (or repetition) of the paging. Therefore, the eNB, if receiving a command of paging transmission from the MME, only has to calculate a paging occasion and transmit paging only for once, without being responsible for confirming the transmission and transmitting acknowledgement to the MME. In other words, in case there is no response to paging transmission, the eNB simply determines that the corresponding UE does not exist in the cell and performs no further operation. However, in the case of a stationary UE, chances are high that paging transmission is not performed properly due to radio conditions or other reasons rather than a paging response is absent because the corresponding UE does not exist in the cell that has transmitted the paging. Suppose the MME requests paging transmission and the eNB transmits only for once without a response to the transmission as in the existing method. If the MME again requests the corresponding cell or overlapping cells to perform retransmission or transmits paging by extending the paging region to include all of the cells belonging to the whole tracking area, S1AP signaling and radio resource efficiency may be degraded.

However, currently there is no defined method for determining/performing whether the eNB requests paging transmission in a cell-specific manner and/or for determining/performing whether the eNB alone performs paging retransmission.

In what follows, the present invention proposes a method for successful paging transmission, which enables an eNB to perform retransmission after the MME performs paging transmission to the eNB in case a UE is located in a specific cell with a high probability (for example, a stationary device or a low mobility device). The method according to the present invention may solve the problem of consuming paging radio resources as the MME unnecessarily performs paging retransmission or as the MME considers a current situation to be a paging failure (for example, a case in which, even though the UE belongs to the cell that has received the previous paging, the corresponding UE does not successfully receive the paging due to a radio quality problem at a physical node) and performs paging transmission by extending the paging range to include all of the cells belonging to the tracking area in addition to the corresponding cell.

As described in the S1401 step of FIG. 14, when transmitting a paging message, the MME may transmit a parameter related to indication indicating the need for paging retransmission of the eNB and/or paging retransmission by including the parameter in a paging message of the S1AP protocol.

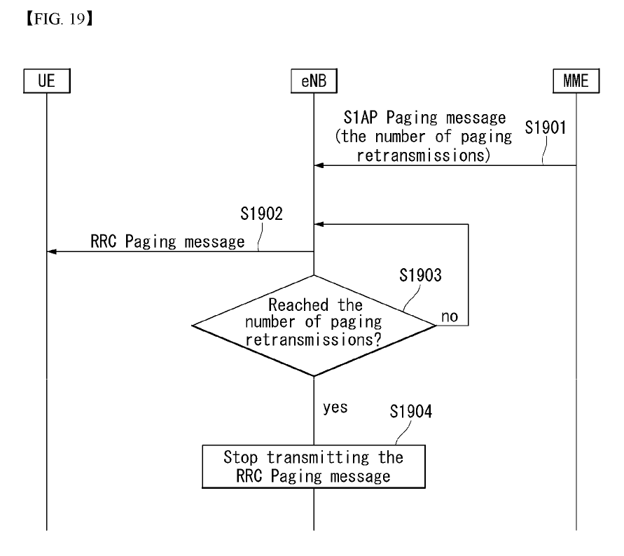

FIG. 16 illustrates a paging transmission method according to one embodiment of the present invention.

Referring to FIG. 16, the MME transmits an S1AP paging message (or paging request) including configuration for the eNB to perform retransmission (or repetition) of an RRC paging message (or paging information) S1601.

Here, the configuration for retransmission (or repetition) of the RRC paging message (or paging information) may include an indicator indicating retransmission of the RRC paging message (or paging information) by the eNB (in what follows, the indicator is called a ‘Paging optimization usage indicator’) and/or the number of retransmissions of the RRC paging message (or paging information) by the eNB.

Here, the MME may specify an eNB that covers the last serving cell to which an UE is expected to belong and transmit an S1AP paging message to the corresponding eNB. In other words, instead of transmitting the S1AP paging message to a plurality of eNBs covering the cell belonging to the TA(s) to which the UE is registered, the MME may transmit the S1AP paging message to the eNB serving the cell where the last location of the UE has been reported or the eNB where the last location of the UE has been reported.

The eNB receiving an S1AP paging message including configuration for retransmission (or repetition) of an RRC paging message (or paging information) from the MME transmits the RRC paging message (or paging information) to the corresponding UE a predetermined number of times (for example, a specific number determined by the eNB, a predefined number, or a number of retransmissions of paging information received from the MME) S1602.

Here, the eNB constructs the RRC paging message (refer to Table 3 above), transmits a DCI to which a CRC scrambled with a P-RNTI is attached to the UE through a PDCCH, and transmits the RRC paging message to the UE through the PDSCH indicated by the PDCCH. In other words, the eNB transmits the RRC paging message to the UE through a PCCH logical channel, PCH transport channel, and PDSCH physical channel.

Here, the predetermined number for transmission of the RRC paging message may be determined in advance.

Also, the predetermined number may be determined according to the number of retransmissions (or repetition) of paging information received through a paging message from the MME.

Also, the eNB may determine a predetermined number of paging retransmission (or repetition) on the basis of (by taking into account) a paging resource and/or the number of UEs to which an RRC paging message is to be transmitted (namely paging queue).

To be more specific, as described above, the paging occasion for each UE may be determined by using the IMSI and DRX value of the UE. And at the paging occasion of a paged UE, the eNB may transmit an RRC paging message to the corresponding UE. However, as shown in Table 3, the maximum number of paging records that may be included in a single RRC paging message (namely the maximum number of UEs that may be paged or paging resources) transmitted by the eNB may be determined in advance. For example, the current LTE/LTE-A system defines the maximum number of paging records that may be included in a single RRC paging message as 16 (‘maxPageRec’=16). Therefore, if the number of UEs to which paging transmission is required at a specific paging occasion exceeds the aforementioned maximum number, the eNB may become incapable of performing paging transmission to all of the paged UEs at the corresponding paging occasion. In this case, paging of a specific UE may be transmitted at the next paging occasion of the corresponding UE. Therefore, the eNB which has received the S1AP paging message from the MME may determine the number of paging retransmissions (or repetition) for the corresponding UE by using a paging resource and/or the number of UEs to which a paging message is to be transmitted (namely, paging queue). And at the paging occasion of the corresponding UE, the eNB transmits an RRC paging message a specific number of times determined by the eNB or a predetermined number of times.

As described above, by including configuration for retransmission (or repetition) of an RRC paging message (or paging information) in the paging message, the MME may indicate to the corresponding eNB that the MME is using cell-specific paging. In other words, if receiving a paging message including configuration for retransmission (or repetition) of the aforementioned RRC paging message (or paging information), the eNB may recognize with a high probability that the corresponding UE is located within a cell served by the eNB.

Therefore, the eNB retransmits (or repeatedly transmits) an RRC paging message to the corresponding UE at the next paging occasion of the corresponding UE even if a retransmitted (or repeatedly transmitted) paging message is not received from the MME.

According to another one embodiment of the present invention, the eNB may determine whether a response with respect to a paging message has been received from the UE and determine whether to perform paging retransmission (or repetition) depending on the reception of a paging response. This operation will be described with reference to a subsequent drawing.

FIG. 17 illustrates a paging transmission method according to one embodiment of the present invention.

Referring to FIG. 17, the MME transmits to the eNB the S1AP paging message including a paging optimization usage indicator indicating paging retransmission (or repetition) by the eNB S1701.

As described above, the MME may specify the eNB that covers the last serving cell in which the UE is expected to be located and transmit the S1AP paging message to the corresponding eNB.

The eNB that has received the S1AP paging message including a paging optimization usage indicator from the MME transmits an RRC paging message to the corresponding UE S1702.

As described above, the eNB constructs the RRC paging message (refer to Table 3 above), transmits a DCI to which a CRC scrambled with a P-RNTI is attached to the UE through a PDCCH, and transmits the RRC paging message to the UE through the PDSCH indicated by the PDCCH. In other words, the eNB transmits the RRC paging message to the UE through a PCCH logical channel, PCH transport channel, and PDSCH physical channel.

Also, the eNB may transmit an RRC paging message to the UE at the paging occasion of the corresponding paged UE determined from the IMSI and DRX value of the corresponding paged UE.

The eNB determines whether a response with respect to the RRC paging message has been received from the corresponding UE S1703.

In other words, if a received S1AP paging message includes a paging optimization usage indicator, the eNB performs the operation of confirming whether the UE has successfully performed reception of the corresponding paging message (namely whether a response with respect to paging information has been received).

At this time, one example of a response to the paging information may be the RRC Connection Request message transmitted from the corresponding UE.

In other words, the eNB may determine whether a paging response has been received from the UE by checking whether the RRC Connection Request message including the identity of the corresponding UE included in the RRC paging message (for example, S-TMSI and IMSI) has been received.

If it is found from the determination result of the S1703 step that a response with respect to the RRC paging message has been received from the corresponding UE, the eNB stops transmitting the RRC paging message to the corresponding UE S1704.

In other words, if receiving an RRC Connection Request message in response to the paging information from the corresponding UE, the eNB may stop transmitting the RRC paging message. In other words, if receiving an RRC Connection Request message including the S-TMSI belonging to the paging information, the eNB may stop transmitting the RRC paging message to the corresponding UE.

On the other hand, if it is found from the determination result of the S1703 step that a response with respect to the RRC paging message has not been received from the corresponding UE, the eNB retransmits (or repeatedly transmits) the RRC paging message to the corresponding UE by branching to the S1702 step.

In other words, if not receiving the RRC Connection Request message including the S-TMSI of the corresponding UE, the eNB again performs RRC paging retransmission (or repetition) at the next paging occasion of the corresponding UE.

Table 7 illustrates the S1AP paging message according to the present invention.

TABLE 7

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | ignore |
| UE Identity Index | M | | 9.2.3.10 | | YES | ignore |
| value | | | | | | |
| UE Paging Identity | M | | 9.2.3.13 | | YES | ignore |
| Paging DRX | O | | 9.2.1.16 | | YES | ignore |
| CN Domain | M | | 9.2.3.22 | | YES | ignore |
| List of TAIs | | 1 | | | YES | ignore |
| >TAI List Item | | 1 . . . <maxnoofTAIs> | | | EACH | ignore |
| >>TAI | M | | 9.2.3.16 | | — | |
| CSG Id List | | 0 . . . 1 | | | GLOBAL | ignore |
| >CSG Id | | 1 . . . <maxnoofCSGId> | 9.2.1.62 | | — | |
| Paging Priority | O | | 9.2.1.78 | | YES | ignore |
| Paging | O | | 9.2.1.XX | | YES | ignore |
| optimization usage | | | | | | |
| indicator | | | | | | |

In describing Table 7, descriptions of the parts that are the same as those of Table 2 will be omitted.

Referring to Table 7, the S1AP paging message includes a paging optimization usage indicator IE.

Table 8 illustrates a paging optimization usage indicator IE according to the present invention.

TABLE 8

| | | | | |
|---|---|---|---|---|
| IE/Group | | | IE type and | Semantics |
| Name | Presence | Range | reference | description |

| | | |
|---|---|---|
| Paging | M | ENUMERATED |
| optimization | | (true, . . .) |
| usage indicator | | |

Referring to Table 8, the paging optimization usage indicator IE indicates whether paging optimization has been used.

The paging optimization usage indicator IE may be of ENUMERATED type; ‘True’ value indicates that paging optimization is used while ‘False’ indicates that paging optimization is not used.

Meanwhile, the S1703 step of FIG. 17 may be performed each time the eNB receives uplink transmission from the UE. For example, each time the eNB receives an RRC message from the UE, the eNB may determine whether an RRC Connection Request message including the S-TMSI belonging to the paging information has been received.

FIG. 18 illustrates a paging transmission method according to one embodiment of the present invention.

Referring to FIG. 18, the MME transmits to the eNB the S1AP paging message including a paging optimization usage indicator indicating paging retransmission (or repetition) by the eNB S1801.

As described above, the MME may specify the eNB that covers the last serving cell in which the UE is expected to be located and first transmit a paging message to the corresponding eNB.

The eNB that has received the S1AP paging message including a paging optimization usage indicator from the MME transmits an RRC paging message to the corresponding UE S1802.

As described above, the eNB constructs the RRC paging message (refer to Table 3 above), transmits a DCI to which a CRC scrambled with a P-RNTI is attached to the UE through a PDCCH, and transmits the RRC paging message to the UE through the PDSCH indicated by the PDCCH. In other words, the eNB transmits the RRC paging message to the UE through a PCCH logical channel, PCH transport channel, and PDSCH physical channel.

Also, the eNB may transmit an RRC paging message to the UE at the paging occasion of the corresponding paged UE determined from the IMSI and DRX value of the corresponding paged UE.

The eNB determines whether the number of paging transmission has reached a predetermined number (for example, a specific number determined by the eNB or a predefined number) S1803.

In other words, the eNB counts the number of paging transmissions and determines whether the number of paging transmission has reached a predetermined number (for example, a specific number determined by the eNB or a predefined number). As one example, the eNB may determine the number of paging retransmissions (or repetition) on the basis of (by taking into account) a paging resource and/or the number of UEs to which a paging message is to be transmitted (namely, paging queue).

If it is found from the determination result of the S1803 step that the number of paging transmissions has reached a predetermined number (for example, a specific number determined by the eNB or a predefined number), the eNB stops transmitting an RRC paging message to the corresponding UE S1805.

On the other hand, if it is found from the determination result of the S1803 step that the number of paging transmissions has not reached a predetermined number (for example, a specific number determined by the eNB or a predefined number) yet, the eNB determines whether it has received a response with respect to the RRC paging message from the corresponding UE S1804.

At this time, one example of a response to the RRC paging information may be the RRC Connection Request message transmitted from the corresponding UE.

In other words, the eNB may determine whether a response with respect to the RRC paging message has been received by checking whether the RRC Connection Request message including the S-TMSI of the corresponding UE has been received.

If it is found from the determination result of the S1804 step that a response with respect to the RRC paging message has been received from the corresponding UE, the eNB stops transmitting a paging message to the corresponding UE S1805.

On the other hand, if it is found from the determination result of the S1703 step that a response with respect to the RRC paging message has not been received from the corresponding UE, the eNB retransmits (or repeatedly transmits) the RRC paging message to the corresponding UE by branching to the S1802 step.

In other words, if not receiving the RRC Connection Request message including the S-TMSI of the corresponding UE, the eNB again performs RRC paging retransmission (or repetition) at the next paging occasion of the corresponding UE.

Meanwhile, although FIG. 18 illustrates an embodiment in which the eNB determines whether the number of paging transmissions has reached a predetermined number (for example, a specific number determined by the eNB or a predefined number) and determines whether a response with respect to the RRC paging message has been received from the UE, the aforementioned two steps may change their order of operation. In other words, the S1803 and the S1804 steps may be reversed.

Also, the S1804 step may be performed independently of the S1803 step each time the eNB receives uplink transmission from the UE. For example, each time the eNB receives an RRC message from the UE, the eNB may determine whether an RRC Connection Request message including the S-TMSI belonging to the paging information has been received.

According to another one embodiment of the present invention, the MME may indicate the number of paging retransmissions (or repetition) for the corresponding UE. This operation will be described with reference to a subsequent drawing.

FIG. 19 illustrates a paging transmission method according to one embodiment of the present invention.

Referring to FIG. 19, the MME transmits to the eNB the S1AP paging message including the number of paging retransmissions (or repetition) S1901.

The MME may set the number of paging retransmissions (or repetition) by taking into account the possibility of the UE's failing to receive a paging message even though the eNB transmits the paging message.

The eNB that has received the S1AP paging message including the number of paging retransmissions (or repetition) from the MME transmits an RRC paging message to the corresponding UE S1902.

As described above, the eNB constructs the RRC paging message (refer to Table 3 above), transmits a DCI to which a CRC scrambled with a P-RNTI is attached to the UE through a PDCCH, and transmits the RRC paging message to the UE through the PDSCH indicated by the PDCCH. In other words, the eNB transmits the RRC paging message to the UE through a PCCH logical channel, PCH transport channel, and PDSCH physical channel.

Also, the eNB may transmit an RRC paging message to the UE at the paging occasion of the corresponding paged UE determined from the IMSI and DRX value of the corresponding paged UE.

The eNB determines whether the number of paging transmissions has reached the number of paging retransmissions (or repetition) received from the MME S1903.

In other words, the eNB counts the number of paging transmissions and determines whether the number of paging transmission has reached the number of paging retransmissions (or repetition) received from the MME.

If it is found from the determination result of the S1903 step that the number of paging transmissions has reached the number of paging retransmissions (or repetition) received from the MME, the eNB stops transmitting an RRC paging message to the corresponding UE S1904.

On the other hand, if it is found from the determination result of the S1903 step that the number of paging transmissions has not reached the number of paging retransmissions (or repetition) received from the MME, the eNB branches to the S1902 step and retransmits (or repetition) an RRC paging message to the corresponding UE.

In other words, the eNB performs paging retransmission (repetition) again at the next paging occasion of the corresponding UE.

Table 9 illustrates the S1AP paging message according to the present invention.

TABLE 9

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | ignore |
| UE Identity Index | M | | 9.2.3.10 | | YES | ignore |
| value | | | | | | |
| UE Paging Identity | M | | 9.2.3.13 | | YES | ignore |
| Paging DRX | O | | 9.2.1.16 | | YES | ignore |
| CN Domain | M | | 9.2.3.22 | | YES | ignore |
| List of TAIs | | 1 | | | YES | ignore |
| >TAI List Item | | 1 . . . <maxnoofTAIs> | | | EACH | ignore |
| >>TAI | M | | 9.2.3.16 | | — | |
| CSG Id List | | 0 . . . 1 | | | GLOBAL | ignore |
| >CSG Id | | 1 . . . <maxnoofCSGId> | 9.2.1.62 | | — | |
| Paging Priority | O | | 9.2.1.78 | | YES | ignore |
| Paging | O | | 9.2.1.XX | | YES | ignore |
| retransmission | | | | | | |

In describing Table 9, descriptions of the parts that are the same as those of Table 2 will be omitted.

Referring to Table 9, the S1AP paging message includes a paging retransmission IE.

Table 10 illustrates a paging retransmission IE according to the present invention.

TABLE 10

| | | | | |
|---|---|---|---|---|
| IE/Group | | | IE type and | Semantics |
| Name | Presence | Range | reference | description |

| | | | |
|---|---|---|---|
| Paging | M | ENUMERATED | When this IE |
| retransmission | | (2, 3, 4, 5, 6, | is present, |
| | | 7, 8 . . .) | eNB shall |
| | | | retransmit |
| | | | the Paging |
| | | | message with |
| | | | given number |
| | | | if not succeed |

Referring to Table 10, the paging retransmission IE indicates the number of paging retransmissions by the eNB.

The paging retransmission IE may be of ENUMERATED type, and the number indicated by the paging retransmission IE (for example, 2, 3, 4, 5, 6, 7, 8, . . . ) indicates the number of paging retransmissions (or repetition) by the eNB.

If receiving the S1AP paging message including the paging retransmission IE from the MME, the eNB may retransmit (or repeatedly transmit) a paging message a given number of times.

According to another one embodiment of the present invention, the eNB may determine whether a response with respect to a paging message has been received from the UE and determine whether to perform paging retransmission (or repetition) depending on the reception of a paging response. This operation will be described with reference to a subsequent drawing.

FIG. 20 illustrates a paging transmission method according to one embodiment of the present invention.

Referring to FIG. 20, the MME transmits to the eNB the S1AP paging message including the number of paging retransmissions (or repetition) S2001.

As described above, the MME may set the number of paging retransmissions (or repetition) by taking into account the possibility of the UE's failing to receive a paging message even though the eNB transmits the paging message.

The eNB that has received the S1AP paging message including the number of paging retransmissions (or repetition) from the MME transmits an RRC paging message to the corresponding UE S2002.

As described above, the eNB constructs the RRC paging message (refer to Table 3 above), transmits a DCI to which a CRC scrambled with a P-RNTI is attached to the UE through a PDCCH, and transmits the RRC paging message to the UE through the PDSCH indicated by the PDCCH. In other words, the eNB transmits the RRC paging message to the UE through a PCCH logical channel, PCH transport channel, and PDSCH physical channel.

Also, the eNB may transmit an RRC paging message to the UE at the paging occasion of the corresponding paged UE determined from the IMSI and DRX value of the corresponding paged UE.

The eNB determines whether the number of paging transmissions has reached the number of paging retransmissions (or repetition) received from the MME S2003.

In other words, the eNB counts the number of paging transmissions and determines whether the number of paging transmission has reached the number of paging retransmissions (or repetition) received from the MME.

If it is found from the determination result of the S2003 step that the number of paging transmissions has reached the number of paging retransmissions (or repetition) received from the MME, the eNB stops transmitting an RRC paging message to the corresponding UE S2005.

Meanwhile, if it is found from the determination result of the S2003 step that the number of paging transmissions has not reached the number of paging retransmissions (or repetition) received from the MME, the eNB determines whether the eNB has received a response with respect to an RRC paging message from the corresponding UE S2004.

At this time, one example of a response to the paging information may be the RRC Connection Request message transmitted from the corresponding UE.

In other words, the eNB may determine whether a paging response has been received from the UE by checking whether the RRC Connection Request message including the identity of the corresponding UE included in the RRC paging message (for example, S-TMSI and IMSI) has been received.

If it is found from the determination result of the S2004 step that a response with respect to the RRC paging message has been received from the corresponding UE, the eNB stops transmitting the RRC paging message to the corresponding UE S2005.

In other words, if receiving an RRC Connection Request message in response to the paging information from the corresponding UE, the eNB may stop transmitting the RRC paging message. In other words, if receiving an RRC Connection Request message including the S-TMSI belonging to the paging information, the eNB may stop transmitting the RRC paging message to the corresponding UE.

On the other hand, if it is found from the determination result of the S2004 step that a paging response has not been received from the corresponding UE, the eNB retransmits (or repeatedly transmits) the RRC paging message to the corresponding UE by branching to the S2002 step.

In other words, the eNB performs paging retransmission (or repetition) again at the next paging occasion of the corresponding UE.

For example, in case the number of paging retransmissions (or repetition) is 2, and the eNB fails to receive an RRC Connection Request message including the S-TMSI of the corresponding UE after transmitting the RRC paging message one time, the eNB transmits the RRC paging message again at the next paging occasion.

Meanwhile, although FIG. 20 illustrates an embodiment in which the eNB determines whether the number of paging transmissions has reached the number of paging retransmissions (or repetition) received from the MME and determines whether a response with respect to the RRC paging message has been received from the UE, the aforementioned two steps may change their order of operation. In other words, the S2003 and the S2004 steps may be reversed.

Also, the S2004 step may be performed independently of the S2003 step each time the eNB receives uplink transmission from the UE. For example, each time the eNB receives an RRC message from the UE, the eNB may determine whether an RRC Connection Request message including the S-TMSI belonging to the paging information has been received.

Meanwhile, in the embodiments described with respect to FIGS. 16 to 20, in case the MME request the eNB to perform retransmission (or repetition) of a paging message (namely to receive the S1AP paging message again), the eNB may retransmit (or repeatedly transmit) the RRC paging message independently of the predetermined number described above.

For example, after transmitting the S1AP paging message to the eNB, the MME activates a timer (for example, T3413). At this time, the time of the timer may be calculated by taking into account the number of paging retransmissions (or repetition) that the MME has transmitted to the eNB or the predefined number of paging retransmissions (or repetition) (namely when the number of paging retransmissions (or repetition) is fixed in advance).

And if receiving a paging response (for example, a Service Request NAS message) from the eNB, the MME stops the timer. On the other hand, if the timer expires before the paging response (for example, the Service Request NAS message) is received, the MME may transmit the S1AP paging message to the eNB to perform paging retransmission (or repetition) to the eNB. Also, at the time, the MME may transmit the S1AP paging message to all of the cells (or eNB serving the corresponding cell) belonging to the TA to which the UE is registered.

Overview of Devices to Which the Present Invention can be Applied

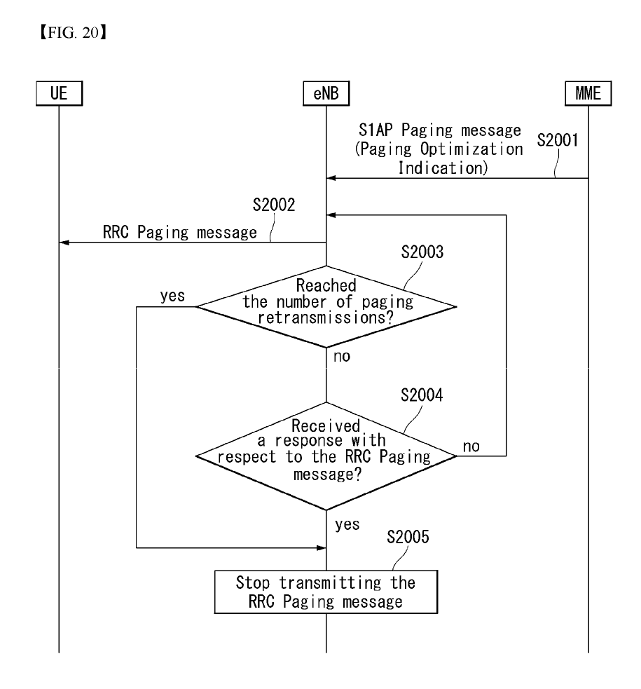

FIG. 21 illustrates a block diagram of a communication device according to one embodiment of the present invention.

With reference to FIG. 21, a wireless communication system comprises a network node 2110 and a plurality of UEs 2120.

A network node 2110 comprises a processor 2111, memory 2112, and communication module 2113. The processor 2111 implements proposed functions, processes and/or methods proposed through FIG. 1 to FIG. 20. The processor 2111 can implement layers of wired/wireless interface protocol. The memory 2112, being connected to the processor 2111, stores various types of information for driving the processor 2111. The communication module 2113, being connected to the processor 2111, transmits and/or receives wired/wireless signals. Examples of the network node 2110 include an eNB, MME, HSS, SGW, PGW, Application Server and so on. In particular, in case the network node 2110 is an eNB, the communication module 2113 can include an Radio Frequency (RF) unit for transmitting/receiving a radio signal.

The UE 2120 comprises a processor 2121, memory 2122, and communication module (or RF unit) 2123. The processor 2121 implements proposed functions, processes and/or methods proposed through FIG. 1 to FIG. 20. The processor 2121 can implement layers of wired/wireless interface protocol. The memory 2122, being connected to the processor 2121, stores various types of information for driving the processor 2121. The communication module 2123, being connected to the processor 2121, transmits and/or receives wired/wireless signals.

The memory 2112, 2122 can be installed inside or outside the processor 2111, 2121 and can be connected to the processor 2111, 2121 through various well-known means. Also, the network node 2110 (in the case of an eNB) and/or the UE 2120 can have a single antenna or multiple antennas.

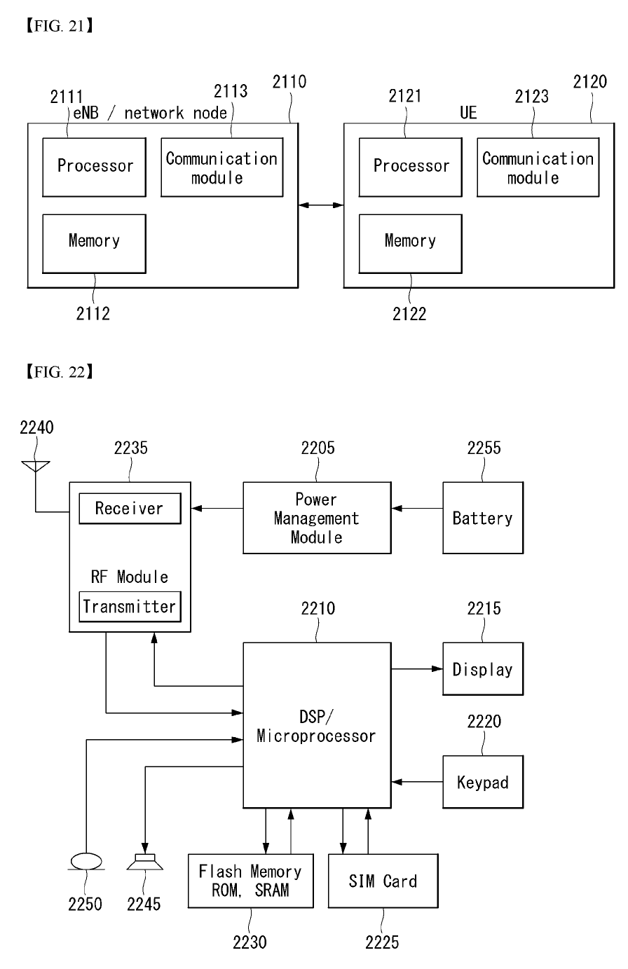

FIG. 22 illustrates a block diagram of a communication device according to one embodiment of the present invention.

In particular, FIG. 22 illustrates the UE of FIG. 21 in more detail.

Referring to FIG. 22, a UE comprises a processor (or digital signal processor (DSP)) 2210, RF module (or RF unit) 2235, power management module 2205, antenna 2240, battery 2255, display 2215, keypad 2220, memory 2230, SIM (Subscriber Identification Module) card 2225 (inclusion of the SIM card is optional), speaker 2245, and microphone 2250. The UE may also comprise a single antenna or a plurality of antennas.

The processor 2210 implements proposed functions, processes and/or methods proposed through FIG. 1 to FIG. 20. The processor 2210 may implement layers of a radio interface protocol.

The memory 2230 is connected to the processor 2210 and stores information related to the operation of the processor 2210. The memory 2230 may be located inside or outside the processor 2210 and may be coupled to the processor 2210 by using various well-known means.

The user enters command information such as a phone number by pushing (or touching) keypad 2220 buttons or through voice activation by using a microphone 2250. The processor 2210 receives the command information and performs a relevant function such as dialing a phone number. The operational data may be extracted from the SIM card 2230 or memory 2230. Also, the processor 2210 may display the command information or operational information on the display 2215 to support the user's recognition thereof or for the user's convenience.

The RF module 2235, being coupled to the processor 2210, transmits and/or receives an RF signal. To initiate communication, the processor 2210 delivers command information to the RF module 2235 so that a radio signal comprising voice communication data, for example, may be transmitted. The RF module 2235 comprises a receiver and a transmitter for receiving and transmitting a radio signal. The antenna 2240 performs the function of transmitting and receiving a radio signal. When receiving a radio signal, the RF module 2235 may deliver the signal and transform the signal into a baseband signal so that the processor 2210 may process the signal. The processed signal may be transformed into audible information output through the speaker 2245 or readable information.

The embodiments described above are a combination of constituting elements and features of the present invention in particular forms. Unless otherwise specified, each constituting element or feature should be regarded to be selective. Each constituting element or feature can be embodied solely without being combined with other constituting element or feature. It is also possible to construct embodiments of the present invention by combining part of constituting elements and/or features. The order of operations illustrated in the embodiments of the present invention can be changed. Part of a structure or feature of an embodiment can be included by another embodiment or replaced with the corresponding structure or feature of another embodiment. It should be clear that embodiments can also be constructed by combining those claims revealing no explicit reference relationship with one another, or the combination can be included as a new claim in a revised application of the present invention afterwards.

Embodiments according to the present invention can be realized by various means, for example, hardware, firmware, software, or a combination thereof. In the case of hardware implementation, the embodiments of the present invention can be implemented by one or more of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, and the like.

In the case of firmware or software implementation, methods according to the embodiment of the present invention can be implemented in the form of a module, procedure, or function performing operations described above. Software codes can be stored in a memory unit and executed by a processor. The memory unit, being located inside or outside the processor, can communicate data with the processor through various means known in the fields of the art.

It should be clearly understood by those skilled in the art that the present invention can be realized in a different, particular form as long as the present invention retains the essential features of the present invention. Therefore, the detailed description above should not be interpreted limitedly from all aspects of the invention but should be regarded as an illustration. The technical scope of the invention should be determined through a reasonable interpretation of the appended claims; all the possible modifications of the present invention within an equivalent scope of the present invention should be understood to belong to the technical scope of the present invention.

### INDUSTRIAL APPLICABILITY

This document discloses a method for transmitting paging in a wireless communication system with examples based on the 3GPP LTE/LTE-A system; however, the present invention can be applied to various other types of wireless communication systems in addition to the 3GPP LTE/LTE-A system.

1. A method for an eNB to transmit a paging message in a wireless communication system, comprising:
receiving a paging message from a Mobility Management Entity (MME);
determining a paging occasion of a User Equipment (UE) based on International Mobile Subscriber Identity (IMSI) and a Discontinuous Reception (DRX) cycle of the UE; and
transmitting paging to a UE on the paging occasion of the UE,
wherein when the paging message includes configuration for repetition of the paging, the paging is repeatedly transmitted from the eNB a number of times that is determined based on the configuration for repetition.

2. (canceled)

3. The method of claim 1, wherein the number of times for paging repetition is determined by the eNB based on a paging resource of the eNB and/or the number of UEs to which the paging information is to be transmitted.

4. The method of claim 1, wherein, the paging is transmitted until the UE successfully receives the paging.

5. The method of claim 4, wherein, if an RRC connection request message is received from the UE in response to the paging information, it is determined that the UE successfully receives the paging.

6. The method of claim 5, wherein the RRC connection request message includes S-TMSI (SAE Temporary Mobile Subscriber Identity) belonging to the paging.

7-8. (canceled)

9. The method of claim 1, wherein, when the paging message is re-received from the MME, the paging is transmitted to the UE irrespective of the number of times for paging repetition.

10. An eNB for transmitting a paging message in a wireless communication system, comprising:
a communication module for transmitting and receiving a wired/wireless signal; and
a processor for controlling the communication module, wherein the processor is configured:
to receive a paging message from a Mobility Management Entity (MME);
to determine a paging occasion of a User Equipment (UE) based on International Mobile Subscriber Identity (IMSI) and a Discontinuous Reception (DRX) cycle of the UE; and
to transmit paging to a UE on the paging occasion of the UE,
wherein when the paging message includes configuration for repetition of the paging, the paging is repeatedly transmitted from the eNB a number of times that is determined based on the configuration for repetition.

11. The method of claim 1, wherein the IMSI and the DRX cycle of the UE are included in the paging message.
